(19) United States
(12) Patent Application Publication
(10) Pub. No.: US 2026/0230818 A1
(43) Pub. Date: Aug. 6, 2026

(54) MANAGEMENT OF AN AMBIENT INTERNET OF THINGS DEVICE IN A MOBILE COMMUNICATION NETWORK

(71) Applicant: QUALCOMM Incorporated, San Diego, CA (US)

(72) Inventors: Ruiming ZHENG, Beijing (CN); Chao WEI, Beijing (CN); Hao XU, Beijing (CN); Kangqi LIU, San Diego, CA (US); Mingxi YIN, Beijing (CN)

(21) Appl. No.: 19/149,178

(22) PCT Filed: Feb. 3, 2023
(86) PCT No.: PCT/CN2023/074337

§ 371 Date: Jul. 18, 2025

(51) Int. Cl. H04W 12/069; H04W 4/80; H04W 12/033; H04W 76/10

(52) U.S. Cl. CPC H04W 12/069; H04W 4/80; H04W 12/033; H04W 76/10

(57) ABSTRACT

An apparatus, such as an ambient Internet of things (A-IoT) device, configured to support registration and management in a mobile communication network (e.g., a cellular communication network) is provided. The apparatus receives a query command, transmits a first message including at least a mobile network assigned tag identifier or an unregistered tag indicator in response to the query command, and receives a second message including at least a temporary identifier for communication with a network node, a reader identifier, or a list of authorized readers.

### BACKGROUND

### Technical Field

The present disclosure relates generally to communication systems, and more particularly, to management of an ambient Internet of things (A-IoT) device in a mobile communication network.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The aspects described herein allow deployment of ambient Internet of things (A-IoT) devices in a mobile communication network (e.g., a cellular communication network, such as a 5G NR network). For example, the A-IoT devices described herein may support registration and management in a mobile communication network through a reader device (also herein referred to as a reader) and a radio access network (RAN) under the control of a core network (CN) (e.g., a 5G CN) in one or more A-IoT device deployment scenarios. The reader device switching and/or A-IoT device mobility are considered in some use cases. Examples of the A-IoT device deployment scenarios may include warehouse inventory management, sensor network (smart grid) applications, automobile manufacturing, location of personal belongings, smart home applications, and/or other suitable deployment scenarios.

The aspects described herein may enable management of an A-IoT device in a mobile communication network including setup of the A-IoT device security for network authentication, registration of the A-IoT device at the mobile communication network, initial association of the A-IoT device to a valid reader, management of the A-IoT device to switch association between different readers (e.g., reader switching), and A-IoT device mobility across different readers.

The aspects described herein include the initial access and connection setup for an A-IoT device and the corresponding signaling design. The aspects described herein further include different types of tag IDs of A-IoT devices, tag authentication procedures, different A-IoT states, reader switching with and without network involved signaling, and procedure optimization, such as group-based query commands and association requests and broadcast of tag contexts.

In an aspect of the disclosure, a method, a computer-readable medium, and an apparatus are provided. The apparatus may be an A-IoT device. The apparatus receives a query command, transmits a first message including at least a mobile network assigned tag identifier or an unregistered tag indicator in response to the query command, and receives a second message including at least a temporary identifier for communication with a network node, a reader identifier, or a list of authorized readers.

In an aspect of the disclosure, a method, a computer-readable medium, and an apparatus are provided. The apparatus may be a mobile network entity, such as a core network device (also referred to as a core network entity). The apparatus receives a request to initiate a context setup for a tag device in a mobile network, performs an authentication operation for the tag device, assigns a tag identifier to the tag device based on the authentication operation, and transmits a context setup message including at least the tag identifier.

In an aspect of the disclosure, a method, a computer-readable medium, and an apparatus are provided. The apparatus may be a reader device. The apparatus transmits a query command, receives a first message including at least a mobile network assigned tag identifier or an unregistered tag indicator in response to the query command, and transmits a second message including at least a temporary identifier for communication with a network node, a reader identifier, or a list of authorized readers.

In an aspect of the disclosure, a method, a computer-readable medium, and an apparatus are provided. The apparatus may be a network node. The apparatus receives a radio resource control setup request for a tag device, transmits a request to initiate a context setup for the tag device, wherein the request includes at least a mobile network assigned tag identifier or an unregistered tag indicator, receives a context setup message including at least the mobile network assigned tag identifier, transmits a radio resource control setup message including at least a temporary identifier for the tag device, and receives a radio resource control setup complete message for the tag device.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 shows a diagram illustrating an example disaggregated base station architecture.

FIG. 5 is a diagram illustrating an example implementation of an A-IoT device and a reader.

FIG. 6 is a diagram illustrating a monostatic deployment scenario for the A-IoT device in a mobile communication network.

FIG. 7 is a diagram illustrating a monostatic deployment scenario for the A-IoT device in a mobile communication network.

FIGS. 8A, 8B, 8C, and 8D illustrate bi-static deployment scenarios for an A-IoT device in a mobile communication network.

FIG. 9 is a diagram illustrating a mobility scenario of an A-IoT device in a mobile communication network.

FIG. 10 is a diagram illustrating a mobility scenario of an A-IoT device in a mobile communication network.

FIG. 11 is a diagram illustrating a mobility scenario of an A-IoT device in a mobile communication network.

FIG. 12 is a signal flow diagram 1200 in accordance with various aspects of the disclosure.

FIG. 13 is a signal flow diagram including an example of the authentication procedure in accordance with various aspects of the disclosure.

FIG. 14 is a signal flow diagram in accordance with various aspects of the disclosure.

FIG. 15 is a diagram illustrating an example set of available states of an A-IoT device as described herein.

FIG. 16 illustrates a signal flow diagram in accordance with various aspects of the disclosure.

FIG. 17 illustrates a signal flow diagram in accordance with various aspects of the disclosure.

FIG. 18 illustrates a signal flow diagram in accordance with various aspects of the disclosure.

FIG. 19 illustrates a signal flow diagram in accordance with various aspects of the disclosure.

FIG. 20 is a signal flow diagram in accordance with various aspects of the disclosure.

FIGS. 21A and 21B are a flowchart of a method of wireless communication.

FIG. 22 is a flowchart of a method of wireless communication.

FIG. 23 is a conceptual data flow diagram illustrating the data flow between different means/components in an example apparatus.

FIG. 24 is a diagram illustrating an example of a hardware implementation for an apparatus employing a processing system.

FIG. 25 is a flowchart of a method of wireless communication.

FIG. 26 is a conceptual data flow diagram illustrating the data flow between different means/components in an example apparatus.

FIG. 27 is a diagram illustrating an example of a hardware implementation for an apparatus employing a processing system.

FIGS. 28A and 28B are a flowchart of a method of wireless communication.

FIG. 29 is a flowchart of a method of wireless communication.

FIG. 30 is a conceptual data flow diagram illustrating the data flow between different means/components in an example apparatus.

FIG. 31 is a diagram illustrating an example of a hardware implementation for an apparatus employing a processing system.

FIG. 32 is a flowchart of a method of wireless communication.

FIG. 33 is a conceptual data flow diagram illustrating the data flow between different means/components in an example apparatus.

FIG. 34 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

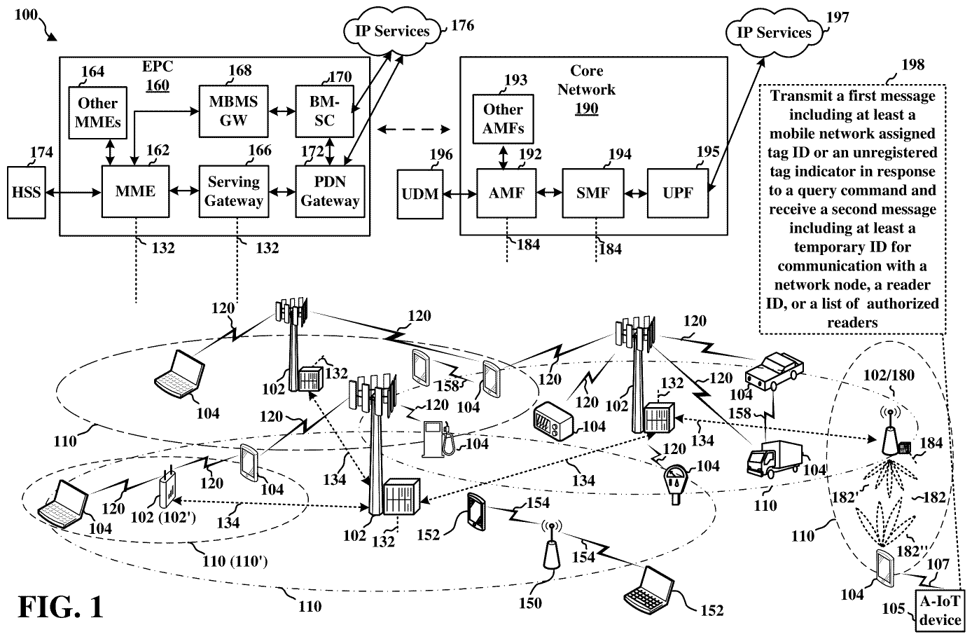

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In FIG. 1, the UE 104 may serve as a reader for a tag device, such as an ambient IoT (A-IoT) device 105. For example, the UE 104 may communicate with the A-IoT device 105 via a communication link 107. In some examples, the communication link 107 may include at least a forward link (FL) or a backscatter link (BL). In some examples, the UE 104 may assist the A-IoT device 105 to initiate a radio resource control (RRC) connection setup with the base station 102.

Referring again to FIG. 1, in certain aspects, the A-IoT device 105 may be configured to transmit a first message including at least a mobile network assigned tag identifier (ID) (e.g., a unique tag ID) or an unregistered tag indicator in response to a query command and receive a second message including at least a temporary ID for communication with a network node, a reader ID, or a list of authorized readers (198). Although the following description may be focused on 5G NR, the concepts described herein may be applicable to other similar areas, such as LTE, LTE-A, CDMA, GSM, and other wireless technologies.

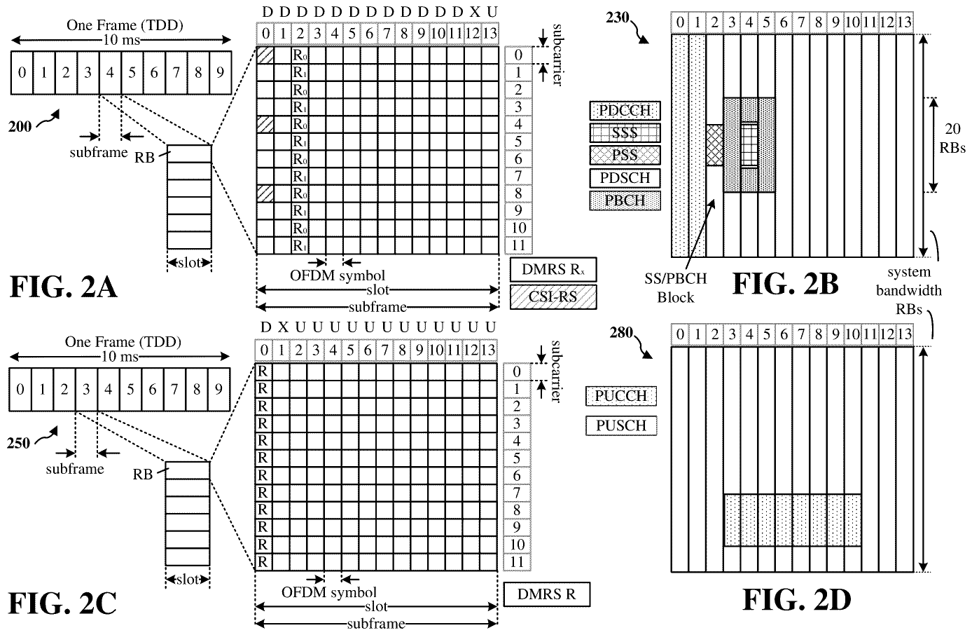

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100ₓ is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

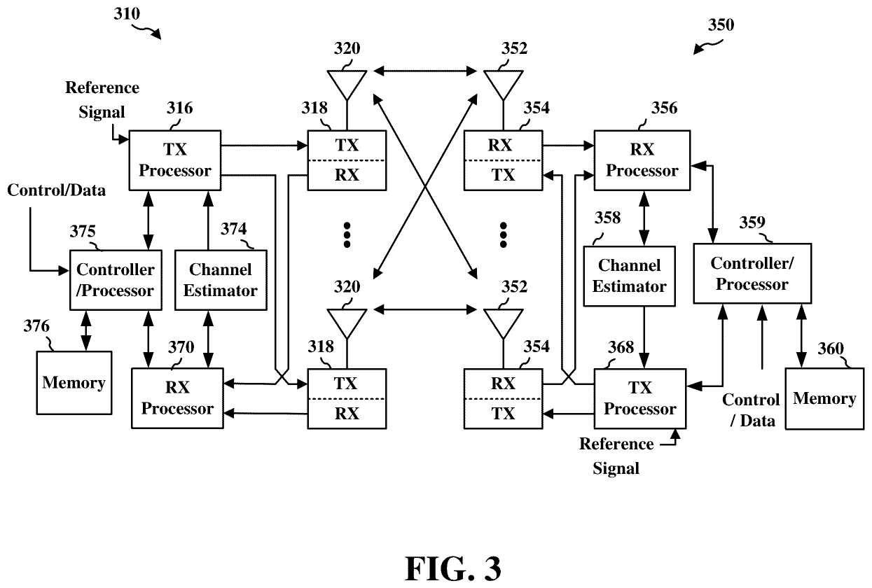

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

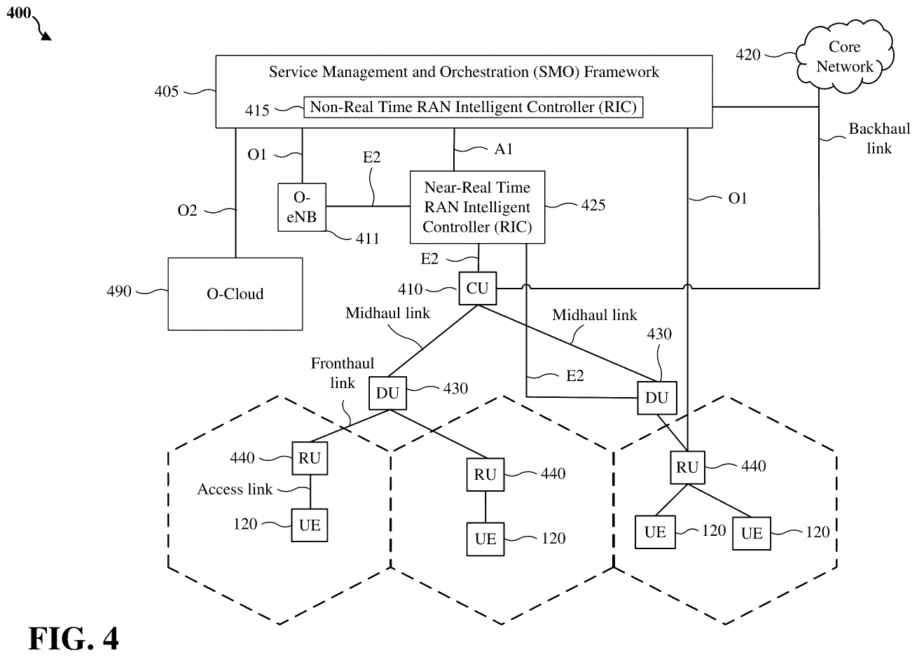

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 450 via one or more radio frequency (RF) access links. In some implementations, the UE 450 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 450. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as Al policies).

Ambient IoT (A-IoT) devices (e.g., passive IoT devices) may be ultra-low complexity and ultra-low power devices and may have complexity and power consumption orders of magnitude lower than existing devices with low complexity and power, such as reduced capability (RedCap) UEs, enhanced Machine Type Communication (eMTC) devices and Narrowband IoT (NB-IoT) devices. There may be different types of A-IoT devices. For example, a first type if A-IoT device (also referred to as a Type A device) may not have a battery or any energy storage capability. Therefore, the first type if A-IoT device is completely dependent on the availability of an external source of energy. A second type of A-IoT device (also referred to as a Type B device) may have a limited energy storage device (e.g., super capacity or conventional capacity) that does not need to be replaced or recharged manually.

In some examples, an A-IoT device (also herein referred to as a tag or a tag device) is typically implemented as a passive device and is not equipped with active RF components. An A-IoT device may perform data transmission based on modulating incident RF signals emitted by an ambient transmitter (e.g., a cellular device, such a smartphone, a base station, etc.). Ambient RF signals may serve not only as a signal resource for backscattering, but also as energy resources for energy harvesting.

It should be noted that the A-IoT devices described herein may have a longer reading range as compared to conventional RF Identification (RFID) devices. The limited reading range (e.g., one or two meters) of such conventional RFID devices makes it difficult to support a large-scale deployment with seamless mobile network coverage.

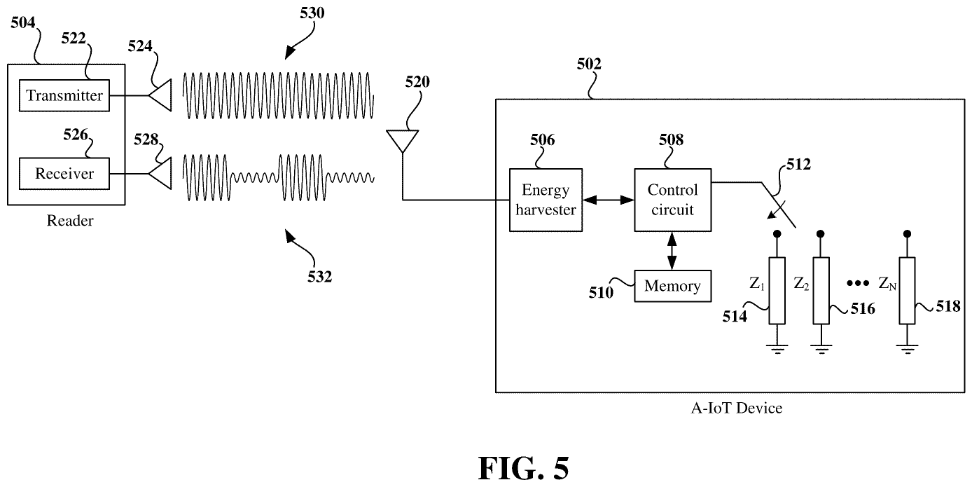

FIG. 5 is a diagram illustrating an example implementation of an A-IoT device 502 and a reader 504. In some examples, the reader 504 may be a UE, a network node (e.g., base station), or other suitable device capable of receiving and processing a modulated backscatter signal. In the example implementation of FIG. 5, the A-IoT device 502 includes an energy harvester 506, a control circuit 508, a memory 510, a switch 512, multiple load impedances, such as a first load impedance (Z₁) 514, a second load impedance (Z₂) 516, and an Nth load impedance (Z_{N}) 518 (e.g., where N is a positive integer), and an antenna 520.

The reader 504 includes a transmitter 522 coupled to a first antenna 524 and a receiver 526 coupled to a second antenna 528. The reader 504 may have full-duplex capability, such that the reader 504 may concurrently transmit and receive signals (e.g., RF signals).

The A-IoT device 502 may communicate with the reader using backscatter communications. In backscatter communications, information may be transmitted by antenna modulation and may not involve the active generation of RF signals. For example, the backscattering device (e.g., the A-IoT device 502) may tune the reflection coefficient of its antenna by switching over a given set of impedances (e.g., using the switch 512 and the load impedances 514, 516, 518), resulting in a varying amount of an incident signal to be backscattered.

When using BPSK modulation, the A-IoT device 502 may switch (e.g., via the switch 512) the value of the load impedance between a very high impedance and a relatively matched load. In the high impedance case, the mismatch between the antenna impedance 520 and load impedance would allow the A-IoT device 502 to reflect all of the power of an incoming signal back to the reader 504. In the matched case, most of the power from an incoming RF signal may be absorbed and very little power may be reflected to the reader 504. The impedance switching frequency may be based on the data rate.

In FIG. 5, the reader 504 may transmit a carrier wave 530, which may be a continuous wave (CW). In some examples, the carrier wave 530 may be an ambient RF signal from a mobile communication network (e.g., 5G NR). The A-IoT device 502 may receive the carrier wave 530 and may backscatter a modulated signal 532. In some examples, the energy harvester 506 may harvest the energy of the carrier wave 530 and may supply power to the control circuit 508 and the memory 510. In some implementations, the control circuit 508 may be a microcontroller and may have data processing capabilities (e.g., public/private key generation, encryption, decryption, and/or other suitable data processing capabilities). The memory 510 may store identification information associated with the A-IoT device 502, such as a tag identifier (ID) and/or an electronic product code (EPC).

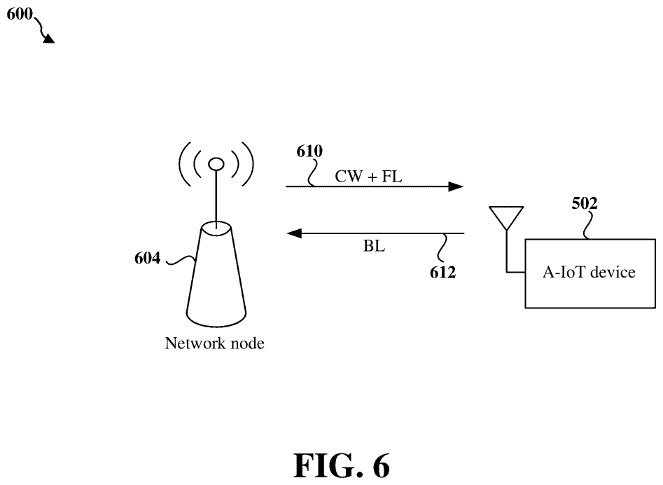

FIG. 6 is a diagram illustrating a monostatic deployment scenario for the A-IoT device 502 in a mobile communication network 600. For example, FIG. 6 shows a full duplex communication between the A-IoT device 502 and a network node 604. In some examples, the network node 604 may be a base station as described herein. In FIG. 6, the transmission 610 from the network node 604 may include a continuous wave and a forward link. The continuous wave may serve as both an energy source and a carrier signal for backscatter communications. The forward link carries control signaling to the A-IoT 502. The transmission 612 from the A-IoT 502 may include a backscatter link which carries data from the A-IoT device 502 to the network node 604.

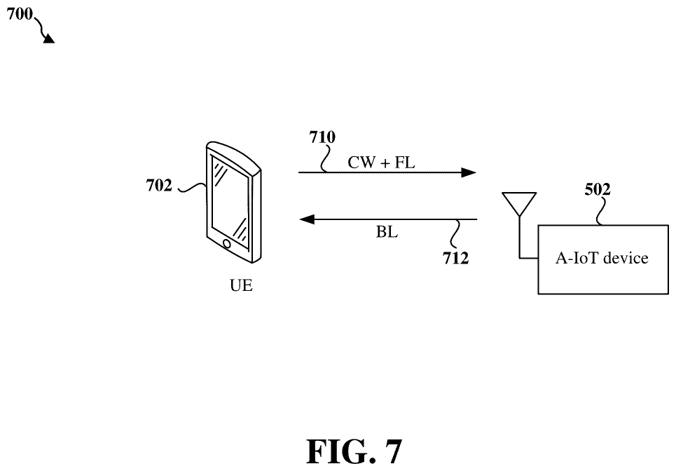

FIG. 7 is a diagram illustrating a monostatic deployment scenario for the A-IoT device 502 in a mobile communication network 700. For example, FIG. 7 shows a full duplex communication between the A-IoT device 502 and a UE 702. In FIG. 7, the transmission 710 from the UE 702 may include a continuous wave and a forward link. The continuous wave may serve as both an energy source and a carrier signal for backscatter communications. The forward link carries control signaling to the A-IoT 502. The transmission 712 from the A-IoT 502 may include a backscatter link which carries data from the A-IoT device 502 to the UE 702.

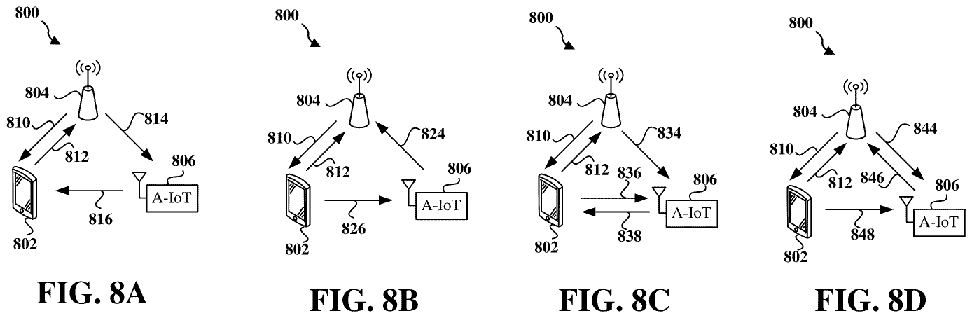

FIGS. 8A, 8B, 8C, and 8D illustrate bi-static deployment scenarios for an A-IoT device 806 in a mobile communication network 800. In FIGS. 8A, 8B, 8C, and 8D, the network node 804 may be a base station configured for half duplex communication. The UE 802 may receive messages from the network node 804 via the DL 810 and may transmit messages to the network node 804 via the UL 812. The DL 810 and UL 812 may be implemented using a Uu interface. The UE 802 may operate as a reader of the A-IoT device 806.

In FIG. 8A, the transmission 814 from the network node 804 to the A-IoT device 806 may include a continuous wave and a forward link. The transmission 816 from the A-IoT device 806 to the UE 802 may include a backscatter link which carries data from the A-IoT device 806 to the UE 802.

In FIG. 8B, the transmission 826 from the UE 802 to the A-IoT device 806 may include a continuous wave and a forward link. The transmission 824 from the A-IoT device 806 to the network node 804 may include a backscatter link which carries data from the A-IoT device 806 to the network node 804.

In FIG. 8C, the transmission 834 from the network node 804 to the A-IoT device 806 may include a continuous wave and the transmission 836 from the UE 802 to the A-IoT device 806 may include a forward link. The transmission 838 from the A-IoT device 806 to the UE 802 may include a backscatter link which carries data from the A-IoT device 806 to the UE 802.

In FIG. 8D, the transmission 848 from the UE 802 to the A-IoT device 806 may include a continuous wave and the transmission 844 from the network node 804 to the A-IoT device 806 may include a forward link. The transmission 846 from the A-IoT device 806 to the network node 804 may include a backscatter link which carries data from the A-IoT device 806 to the network node 804.

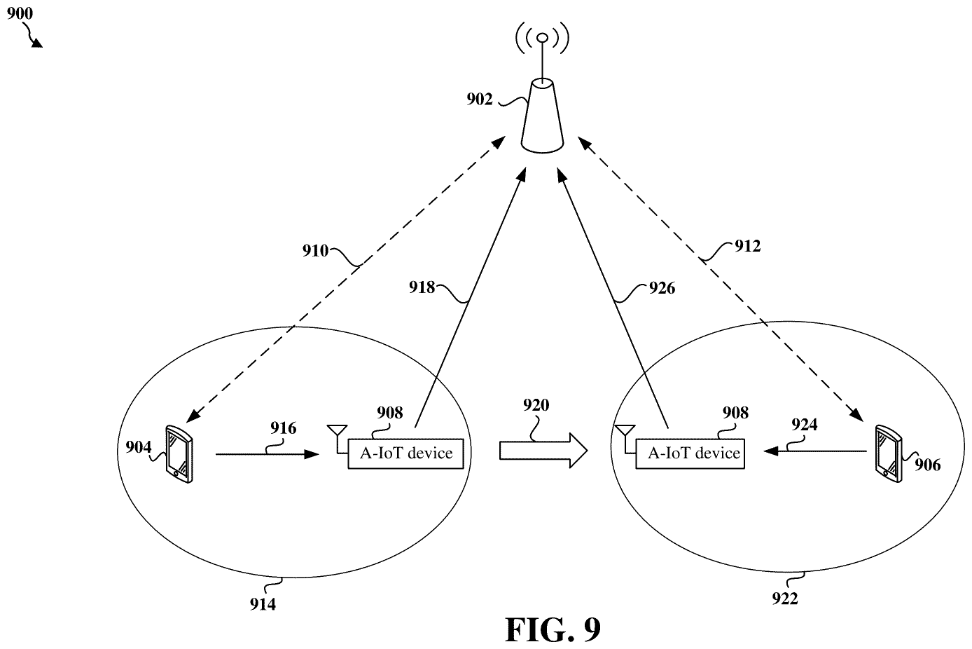

In the aspects described herein, a reader device (also herein referred to simply as a reader) capable of receiving RF signals from an A-IoT device may be implemented as a UE or a network node. In the aspects described herein, an RF source from which an A-IoT device may harvest energy and receive messages (e.g., continuous wave and forward link) may be implemented as a UE or a network node. In some examples, a reader device and an RF source may be paired with respect to a forward link and a backscatter link of an A-IoT device. For example, and as shown in FIG. 9, an A-IoT device 908 may receive a continuous wave signal from an RF source (e.g., a UE 904) and may reflect and modulate the incoming signal (e.g., continuous wave signal) to the reader.

FIG. 9 is a diagram 900 illustrating a first mobility scenario for an A-IoT device 908. In FIG. 9, a network node 902 may be in communication with a first UE 904 in a first DL coverage area 914 via a first Uu link 910 and with a second UE 906 in a second DL coverage area 922 via a second Uu link 912. In FIG. 9, each of the first and second UEs 904, 906 may operate as an RF source (e.g., for RF transmissions) for the A-IoT device 908, but not as a reader (e.g., not for RF reception) for the A-IoT device 908. The network node 902 may operate as a reader (e.g., for RF reception) for the A-IoT device 908, but not as an RF source (e.g., for RF transmissions) for the A-IoT device 908.

In FIG. 9, the A-IoT device 908 receives a continuous wave signal 916 from an RF source (e.g., the UE 904) and reflects and modulates the continuous wave signal 916 to the reader (e.g., the network node 902) via a backscatter link 918. After the A-IoT device 908 moves 920 to the second DL coverage area 922, the A-IoT device 908 may switch its RF source from the UE 904 to the UE 906 (e.g., the A-IoT device 908 in the second DL coverage area 922 receives a continuous wave signal 924 from the UE 906 and no longer receives the continuous wave signal 916 from the UE 904). It should be noted that the A-IoT device 908 maintains the reader (e.g., the network node 902) after the A-IoT device 908 moves to the second DL coverage area 922.

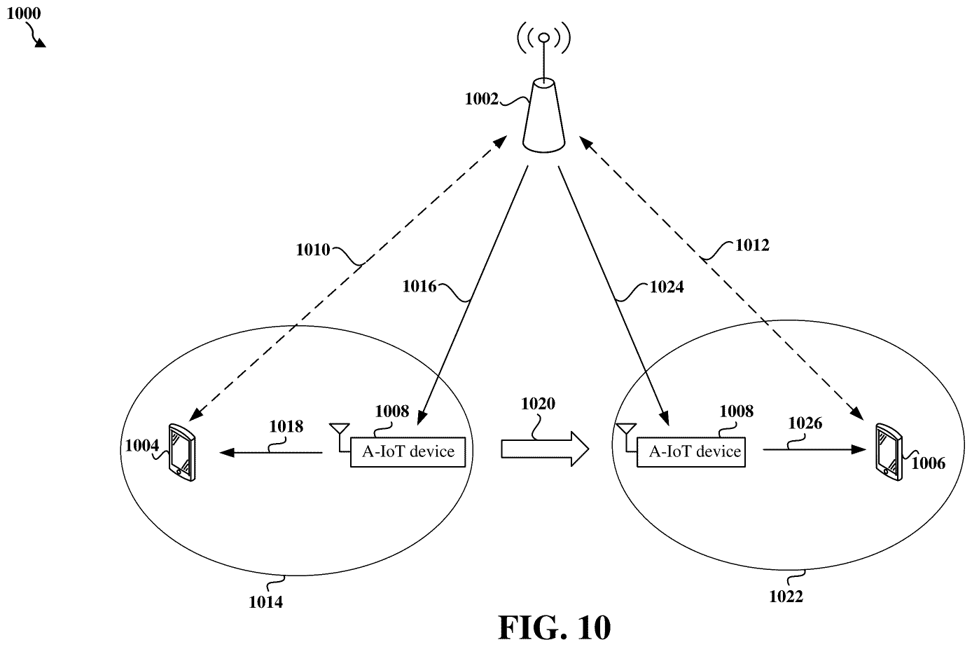

FIG. 10 is a diagram 1000 illustrating a second mobility scenario for an A-IoT device 1008. In FIG. 10, a network node 1002 may be in communication with a first UE 1004 in a first UL coverage area 1014 via a first Uu link 1010 and with a second UE 1006 in a second UL coverage area 1022 via a second Uu link 1012. In FIG. 10, each of the first and second UEs 1004, 1006 may operate as a reader (e.g., for RF reception) for the A-IoT device 1008, but not as an RF source (e.g., for RF transmissions) for the A-IoT device 1008. The network node 1002 may operate as an RF source (e.g., for RF transmissions) for the A-IoT device 1008, but not as a reader (e.g., not for RF reception) for the A-IoT device 1008.

In FIG. 10, the A-IoT device 908 receives a continuous wave signal 1016 from an RF source (e.g., the network node 1002) and reflects and modulates the continuous wave signal 1016 to the reader (e.g., the UE 1004) via a backscatter link 1018. After the A-IoT device 1008 moves 1020 to the second UL coverage area 1022, the A-IoT device 1008 may switch its reader from the UE 1004 to the UE 1006 (e.g., the UE 1006 receives the backscatter link 1026 and the UE 1004 no longer receives the backscatter link 1018). It should be noted that the A-IoT device 1008 maintains the reader (e.g., the network node 1002) after the A-IoT device 1008 moves to the second UL coverage area 1022.

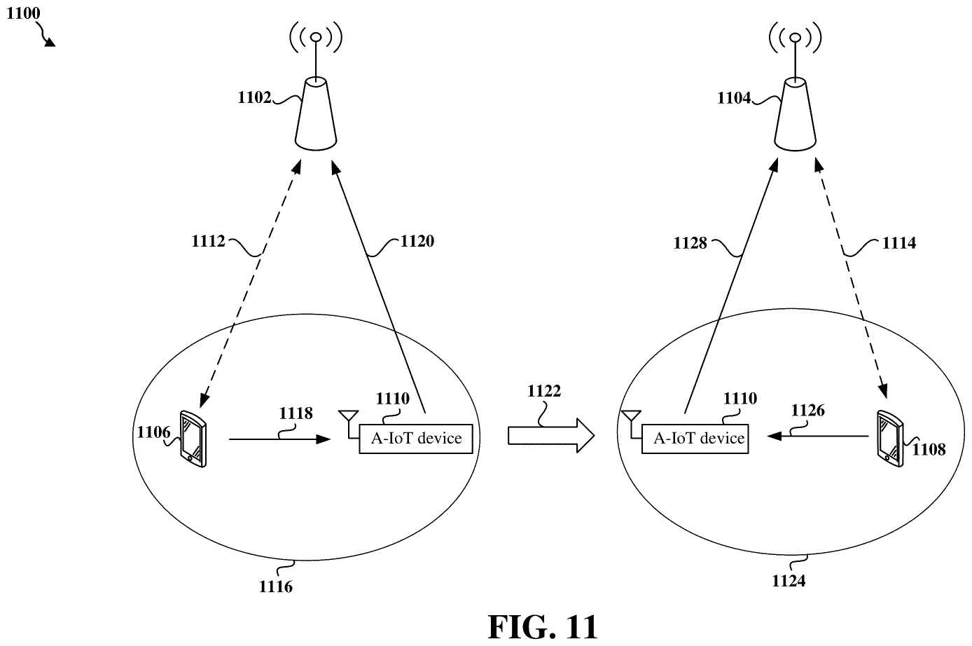

FIG. 11 is a diagram 1100 illustrating a third mobility scenario for an A-IoT device 1110. In FIG. 11, a first network node 1102 may be in communication with a first UE 1106 in a first coverage area 1116 via a first Uu link 1112 and a second network node 1104 may be in communication with a second UE 1108 in a second coverage area 1124 via a second Uu link 1114. In FIG. 11, each of the first and second network nodes 1102, 1104 may operate as a reader (e.g., for RF reception) for the A-IoT device 1110, but not as an RF source (e.g., for RF transmissions) for the A-IoT device 1110. Each of the first and second UEs 1106, 1108 may operate as an RF source (e.g., for RF transmissions) for the A-IoT device 1110, but not as a reader (e.g., not for RF reception) for the A-IoT device 1110.

In FIG. 11, the A-IoT device 1110 receives a continuous wave signal 1118 from an RF source (e.g., the first UE 1106) and reflects and modulates the continuous wave signal 1118 to the reader (e.g., the network node 1102) via a backscatter link 1120. After the A-IoT device 1110 moves 1122 to the second coverage area 1124, the A-IoT device 1110 may switch both its RF source and reader from the UE 1106 and the network node 1102 to the UE 1108 and the network node 1104. For example, the second network node 1104 receives the backscatter link 1128 and the first network node 1102 no longer receives the backscatter link 1120), and the A-IoT device 1110 receives the continuous wave signal 1126 from the second UE 1108 and no longer receives the continuous wave signal 1118 from the first UE 1106.

The A-IoT devices described herein may support registration and management in a mobile communication network through a reader device (also herein referred to as a reader) and a radio access network (RAN) under the control of a core network (CN) (e.g., a 5G CN) in one or more A-IoT device deployment scenarios. The reader device switching and/or A-IoT device mobility are considered in some use cases. Examples of the A-IoT device deployment scenarios may include warehouse inventory management, sensor network (smart grid) applications, automobile manufacturing, location of personal belongings, smart home applications, and/or other suitable deployment scenarios.

The aspects described herein may enable management of an A-IoT device in a mobile communication network including setup of the A-IoT device security for network authentication, registration of the A-IoT device at the mobile communication network, initial association of the A-IoT device to a valid reader, management of the A-IoT device to switch association between different readers (e.g., reader switching), and A-IoT device mobility across different readers.

The aspects described herein include the initial access and connection setup for an A-IoT device and the corresponding signaling design. The aspects described herein further include different types of tag IDs of A-IoT devices, tag authentication procedures, different A-IoT states, reader switching with and without network involved signaling, and procedure optimization, such as group-based query commands and association requests and broadcast of tag contexts.

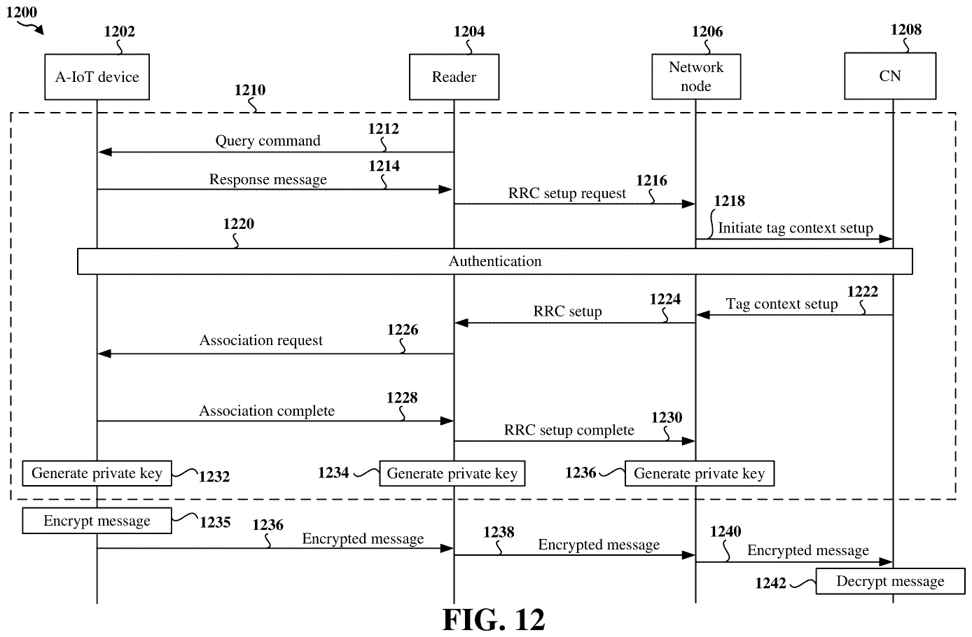

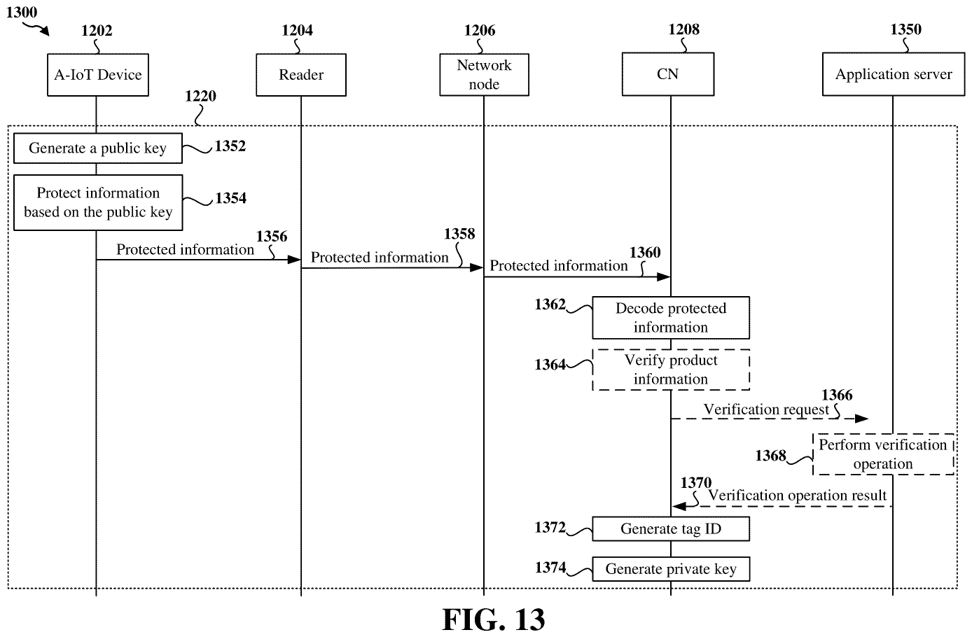

FIG. 12 is a signal flow diagram 1200 in accordance with various aspects of the disclosure. FIG. 12 includes an A-IoT device 1202, a reader 1204, a network node 1206, and a core network (CN) 1208. In some examples, the network node 1206 may be a base station. In some examples, the reader 1204 may be a UE. In FIG. 12, the reader 1204 and the network node 1206 may perform a relay operation (e.g., a layer-2 and/or a layer-3 relay-like operation) between the A-IoT device 1202 and the CN 1208. In the signal flow diagram 1200, the portion 1210 indicated with dashed lines includes a connection setup procedure (e.g., an RRC connection setup procedure).

The reader 1204 may transmit a query command 1212. In the aspects described herein, a query command may be a message requesting basic information from an A-IoT device, such as a tag ID. The A-IoT device 1202 may receive the query command 1212 and may transmit a response message 1214 in response to the query command 1212. In some examples, the response message 1214 may include a unique tag ID previously assigned by a mobile network entity, such as the CN 1208. In some examples, the response message 1214 may include an unregistered tag indicator (also referred to as a new tag indicator) if the A-IoT device 1202 has not been assigned a unique tag ID. For example, the response message 1214 may include an unregistered tag indicator if the A-IoT device 1202 has not previously registered with a mobile network entity, such as the CN 1208. In some aspects, the unregistered tag indicator may be a tag product ID or part of the tag product ID.

In some examples, the A-IoT device 1202 may include a reader ID in the response message 1214 with the unique tag ID. In some examples, the reader ID may identify the reader from which the A-IoT device 1202 received the unique tag ID. In some cases, the reader ID may be associated with the reader 1204.

In some examples, if the A-IoT device 1202 has not previously registered with a mobile network entity, such as the CN 1208, the A-IoT device 1202 may include a tag product ID associated with the A-IoT device 1202 (or a portion of the tag product ID), which may serve as an unregistered tag indicator, in the response message 1214. In some examples, the tag product ID may include an identifier assigned by a manufacturer or vendor of the tag itself and may be stored in a tag ID (TID) memory of the tag at the A-IoT device 1202. In some examples, the tag product ID may further include an electronic product code (EPC) associated with the A-IoT device 1202. The EPC may be an identifier that gives a unique identity to a specific product (e.g., the A-IoT device 1202) that includes the tag. In some examples, the EPC may be associated with a standards organization, such as EPCglobal™. In other examples, the EPC code may be a non-EPCglobal™ application.

In some examples, the response message 1214 may include security information. In the aspects described herein, security information may refer to information associated with signaling integrity protection and/or ciphering. In one example, the security information may be an authentication token to facilitate authentication of a message from an A-IoT device at a receiver device. In one non-limiting example, the security information may be a 16-bit string.

If the A-IoT device 1202 is not registered with a mobile network entity (e.g., the CN 1208), the reader 1204 may assist the A-IoT device 1202 to initiate an RRC connection setup with the network node 1206. For example, the reader 1204 may transmit an RRC setup request 1216 to the network node 1206.

In some examples, an RRC setup request (e.g., the RRC setup request 1216) may be a message that requests establishment of an RRC connection at a network node (e.g., the network node 1206). In some examples, an RRC setup request may include an identifier of an A-IoT device (e.g., a unique tag ID). In some examples, the RRC setup request may further include a connection establishment clause (e.g., information as to a reason for establishing the connection) and/or other suitable information.

The network node 1206 may receive the RRC setup request 1216 and may attempt to identify the A-IoT device 1202. If the network node 1206 is unable to identify the A-IoT device 1202, the network node 1206 may transmit an initiate tag context setup message 1218. In some examples, the initiate tag context setup message 1218 may be configured to initiate a tag context setup procedure at the CN 1208.

In some examples, an initiate tag context setup message (also referred to as an initial context setup request), such as the initiate tag context setup message 1218, may trigger an initial context setup procedure at a mobile network entity (e.g., at an AMF of the core network). For example, a tag context (e.g., for an A-IoT device) may include a bearer context, a security context, and/or other parameters used for communication with the A-IoT device.

The CN 1208 may perform an authentication procedure 1220 in response to the initiate tag context setup message 1218. The authentication procedure 1220 may allow the CN 1208 to register the A-IoT device 1202. For example, the CN 1208 may perform the authentication procedure 1220 with the A-IoT device 1202 to generate and assign a unique tag ID for the A-IoT device 1202. In the aspects described herein, the A-IoT device 1202 may be considered registered at the CN 1208 when a unique tag ID has been assigned to the A-IoT device 1202. An example of the authentication procedure 1220 is described herein with reference to FIG. 13.

The CN 1208 may transmit a tag context setup message 1222 after completing the authentication procedure 1220. In some examples, the tag context setup message 1222 may include the unique tag ID. The network node 1206 may receive the tag context setup message 1222.

The network node 1206 may transmit an RRC setup message 1224 for the A-IoT device 1202 in response to the tag context setup message 1222. In some examples, the RRC setup message 1224 may include the unique tag ID. In some examples, the RRC setup message 1224 may include a temporary identifier. For example, the temporary identifier may be a radio network temporary identifier (RNTI) for the A-IoT device 1202 (also referred to as a tag-RNTI). The A-IoT device 1202 may use the temporary identifier (e.g., tag-RNTI) to monitor a physical (PHY) channel. In some examples, the network node 1206 may forward the unique tag ID to the A-IoT device 1202.

In some examples, an RRC setup message (e.g., the RRC setup message 1224) may include an identity of an A-IoT device (e.g., a unique tag ID). In some examples, the RRC setup message may further include radio bearer information (e.g., a signaling radio bearer configuration for RRC messages, such as an SRB1 configuration), cell configuration information (e.g., PDCCH and PDSCH channel configurations to enable reception of SRB1), and/or other suitable information.

In some examples, a network node may use a tag-RNTI of an A-IoT device to scramble cyclic redundancy check (CRC) bits of a radio channel message (e.g., a PDCCH) to the A-IoT device. The A-IoT device may then use the tag-RNTI to decode the radio channel message.

The reader 1204 may receive the RRC setup message 1224. The reader may transmit an association request 1226 to associate the A-IoT device 1202 with the reader 1204. The association request 1226 may include the temporary identifier (e.g., tag-RNTI), the reader ID, and a list including one or more authorized readers (also referred to as an authorized reader list). In some examples, the reader may obtain the unique tag ID from the RRC setup message 1224 and may include the unique tag ID in the association request 1226.

The A-IoT device 1202 may receive the association request 1226. The A-IoT device 1202 may associate at least the unique tag ID to the reader ID in response to the association request 1226. The A-IoT device 1202 may transmit an association complete message 1228 after the A-IoT device 1202 has associated its unique tag ID with at least the temporary identifier, the reader identifier, or the list including one or more authorized readers.

The reader 1204 may receive the association complete message 1228 and may transmit an RRC setup complete message 1230. In some examples, an RRC setup complete message (e.g., the RRC setup complete message 1230) confirms successful completion of an RRC connection establishment procedure.

The A-IoT device 1202, the reader 1204, the network node 1206, and the CN 1208 may each generate a private key at 1232, 1234, 1236, 1374 (e.g., in FIG. 13). In some examples, the A-IoT device 1202 may generate the private key at 1232 based on a public key and the unique tag ID. In some examples, the A-IoT device 1202 may generate the private key at 1232 based on a public key, the unique tag ID, and a reader ID of a reader associated (e.g., paired) with the A-IoT device 1202.

The A-IoT device 1202, the reader 1204, the network node 1206, and the CN 1208 may use the private key for communications between the A-IoT device 1202 and the CN 1208. In some examples, the private key may be used to protect (e.g., integrity protection and ciphering) signal transmissions (e.g., data transmissions) from the A-IoT device 1202 and/or signal transmissions received at the A-IoT device 1202.

For example, with reference to FIG. 12, at 1235, the A-IoT device 1202 may encrypt a message (e.g., a data message intended for the CN 1208) based on the private key to generate an encrypted message. At 1236, the A-IoT device 1202 may transmit the encrypted message to the reader 1204. At 1238, the reader 1204 may forward the encrypted message to the network node 1206. At 1240, the network node 1206 may forward the encrypted message to the CN 1208. At 1242, the CN 1208 may decrypt the encrypted message using the private key. In some examples, the reader 1204 and/or the network code 1206 may decrypt the encrypted message using the private key.

FIG. 13 is a signal flow diagram including an example of the authentication procedure 1220 in accordance with various aspects of the disclosure. FIG. 13 includes the A-IoT device 1202, the reader 1204, the network node 1206, the CN 1208, and an application server 1350.

At 1352, the A-IoT device 1202 generates a public key. In some examples, the A-IoT device 1202 generates the public key based on a tag product ID, an electronic product code (EPC), and/or other product related information. For example, the tag product ID may be an identifier assigned by a manufacturer or vendor of the tag itself and may be stored in a tag ID (TID) memory of the tag. For example, the EPC may be an identifier that gives a unique identity to a specific product (e.g., the A-IoT device 1202) that includes the tag. In some examples, the EPC may be associated with a standards organization, such as EPCglobal™. In other examples, the EPC code may be a non-EPCglobal™ application.

In some aspects, the public key may only be decoded by the application server 1350 or the CN 1208. For example, a network function at the CN 1208 may decode the public key. In some aspects, no reader may be able to decode the public key with authorization by the CN 1208.

At 1354, the A-IoT device 1202 may protect information (e.g., product information) associated with the A-IoT device 1202 based on the public key to generate protected information 1356. In some examples, the product information may include at least the TID and EPC associated with the A-IoT device 1202. In some examples, the A-IoT device 1202 may generate the protected information based on the public key by applying a key encapsulation mechanism (KEM) to encapsulate the information.

At 1356, the A-IoT device 1202 may transmit the protected information to the CN 1208 (e.g., via the reader 1204 and the network node 1206) to set up a security tunnel between the A-IoT device 1202 and the CN 1208 or the application server 1350. In some aspects, a network function of the CN 1208 or the application server 1350 may decode the protected information. In these aspects, other network entities (e.g., the reader 1204, the network node 1206) may not decode the protected information. In some aspects, the reader 1204 is not allowed to send or receive user data to and/or from the A-IoT device 1202 before the authentication procedure 1220 is complete.

At 1358, the reader 1204 may forward the protected information to the network node 1206. At 1360, the network node 1206 may forward the protected information to the CN 1208. At 1362, the CN 1208 may decode the protected information.

The CN 1208 or the application server 1350 may be responsible for the manufacturer's information and application information verification and authorization. For example, at 1364, the CN 1208 may attempt to verify the product information. In some aspects, the CN 1208 may optionally request the application server 1350 to verify the product information. For example, the CN 1208 may transmit a verification request 1366 including the product information of the A-IoT device 1202. At 1368, the application server 1350 may perform a verification operation for the product information in response to the verification request 1366. The application server 1350 may transmit a verification operation result 1370 to the CN 1208.

If the CN 1208 determines that the product information is valid (e.g., at 1364 or via the verification operation result 1370) and allowed to access the mobile network, the CN 1208 may consider the A-IoT device 1202 to be valid and may generate a unique tag ID at 1372 for the A-IoT device 1202. The A-IoT device 1202 may use the unique tag ID to communicate with the reader 1204.

The CN 1208 may generate the unique tag ID using different types of information. In one example, the CN 1208 may generate the unique tag ID based on the previously described tag product ID (e.g., a tag ID stored in a TID memory) or a portion of the tag product ID and the EPC. For example, the CN 1208 may generate the unique tag ID by concatenating the tag ID stored in a TID memory and the EPC. The EPC may be similar to that of a radio frequency ID (RFID) product following the RFID specification and may be verified by the application server 1350. In some examples, other entities (e.g., the reader 1204, the network node 1206, the CN 1208) may not be able to verify the EPC.

In another example, the CN 1208 may generate the unique tag ID by assigning a value that uniquely identifies the A-IoT device 1202 within a tracking area. In some examples, the value may be a temporary mobile subscriber identity (TMSI). For example, when the A-IoT device 1202 has registered in the CN 1208 and the CN 1208 completes the authentication procedure 1220, the unique tag ID is assigned by CN 1208.

In another example, if the A-IoT device 1202 is not registered with a mobile network entity (e.g., the CN 1208) or is not able to access the mobile network, the CN 1208 may generate a random value and may assign the random value as the unique tag ID.

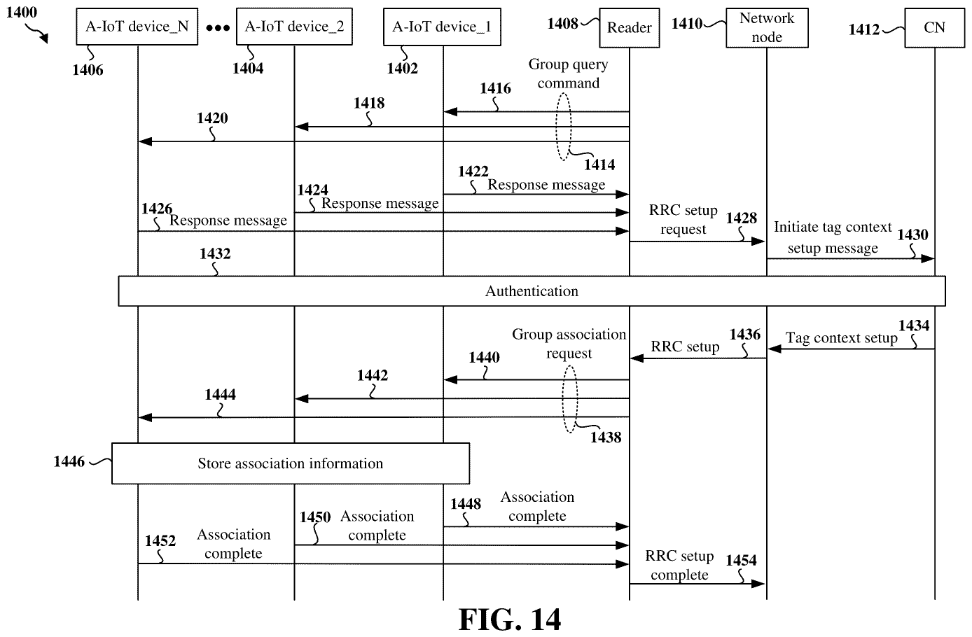

FIG. 14 is a signal flow diagram 1400 in accordance with various aspects of the disclosure. FIG. 14 includes multiple A-IoT devices, such as a first A-IoT device 1402, a second A-IoT device 1404, and an Nth A-IoT device 1406 (e.g., where N is a positive integer). FIG. 14 further includes a reader 1408, a network node 1410, and a core network (CN) 1412. In FIG. 14, the reader 1408 and the network node 1410 may perform a relay operation (e.g., a layer-2 and/or a layer-3 relay-like operation) between the A-IoT devices 1402, 1404, 1406 and the CN 1412. In some aspects, the signal flow diagram 1400 represents a connection setup procedure (e.g., an RRC connection setup procedure).

The reader 1408 may transmit a group query command 1414. In some aspects, the group query command 1414 may be included in one or more broadcast messages 1416, 1418, 1420 to the multiple A-IoT devices 1402, 1404, 1406. In some examples, the group query command 1414 may be included in a single broadcast message that may be received at each of the A-IoT devices 1402, 1404, 1406.

In some examples, the group query command 1414 may include the identifiers (e.g., unique tag IDs assigned by the CN 1412) of the A-IoT devices 1402, 1404, 1406. For example, the group query command 1414 may include a first unique tag ID associated with the first A-IoT device 1402, a second unique tag ID associated with the second A-IoT device 1404, and so on.

Each of the A-IoT devices 1402, 1404, 1406 may transmit a response message in response to the group query command 1414. For example, the first A-IoT device 1402 may transmit a first response message 1422, the second A-IoT device 1404 may transmit a second response message 1424, and the Nth A-IoT device 1406 may transmit an Nth response message 1426. In some examples, each of the response messages 1422, 1424, 1426 may include the unique tag ID of the transmitting A-IoT device. For example, the first response message 1422 may include the unique tag ID of the first A-IoT device 1402, the second response message 1424 may include the unique tag ID of the second A-IoT device 1404, and the Nth response message 1426 may include the unique tag ID of the Nth A-IoT device 1406.

In some examples, one or more of the response messages 1422, 1424, 1426 may include a reader ID with a unique tag ID. In some examples, the reader ID may identify the reader from which an A-IoT device received its unique tag ID. In one example scenario, if each of the A-IoT devices 1402, 1404, 1406 previously received a unique tag ID from the reader 1408, each of the response messages 1422, 1424, 1426 may include the reader ID associated with the reader 1408.

In some examples, each of the response messages 1422, 1424, 1426 may include security information. For example, the security information may be a value that enables an integrity check of a response message at a receiving device. For example, the first A-IoT device 1402 may include first security information in the response message 1422, the second A-IoT device 1404 may include second security information in the response message 1424, and the Nth A-IoT device 1406 may include Nth security information in the response message 1426.

If the A-IoT devices 1402, 1404, 1406 are not currently connected to the network node 1410, the reader 1408 may assist the A-IoT devices 1402, 1404, 1406 to initiate a group RRC connection setup with the network node 1410. For example, the reader 1408 may transmit an RRC setup request 1428 to the network node 1410 to assist the A-IoT devices 1402, 1404, 1406 with establishment of an RRC connection to the network node 1410.

The CN 1412 may perform an authentication procedure 1432 in response to the initiate tag context setup message 1430. In some examples, the CN 1412 may perform the authentication procedure 1432 to determine whether each of the A-IoT devices 1402, 1404, 1406 is allowed to access the CN 1412, an application server, and/or other mobile network entity. The CN 1412 may transmit a tag context setup message 1434 after completing the authentication procedure 1432. The network node 1410 may receive the tag context setup message 1434.

The network node 1410 may transmit an RRC setup message 1436 for the A-IoT devices 1402, 1404, 1406 in response to the tag context setup message 1434. In some examples, the RRC setup message 1436 may include a temporary identifier. For example, the temporary identifier may be a radio network temporary identifier (RNTI) for the A-IoT devices 1402, 1404, 1406 (also referred to as a group tag-RNTI). The A-IoT devices 1402, 1404, 1406 may use the temporary identifier (e.g., group tag-RNTI) to monitor a physical (PHY) channel.

The reader 1408 may receive the RRC setup message 1436. The reader may transmit a group association request 1438 (also referred to as a group association request message) to associate the A-IoT devices 1402, 1404, 1406 with the reader 1408. The group association request 1438 may include a group of unique tag IDs associated with the A-IoT devices 1402, 1404, 1406, the temporary identifier (e.g., the group tag-RNTI), the reader ID, and a list including one or more authorized readers (also referred to as an authorized reader list).

The A-IoT devices 1402, 1404, 1406 may receive the group association request 1438. In some aspects, the group association request 1438 may be included in one or more broadcast messages 1440, 1442, 1444 to the A-IoT devices 1402, 1404, 1406. In some examples, the group association request 1438 may be included in a single broadcast message that may be received at each of the A-IoT devices 1402, 1404, 1406.

At 1446, each of the A-IoT devices 1402, 1404, 1406 may store association information based on the group association request 1438. “Association information” as used herein may include a tag-RNTI, a reader ID, an authorized reader list, and/or other suitable information an A-IoT device may use when associated with a reader (e.g., a serving reader) and/or when switching an association to a different reader (e.g., a target reader). For example, at 1446, each of the A-IoT devices 1402, 1404, 1406 may store the group tag-RNTI, the reader ID of the reader 1408 (also referred to as a serving reader), and the authorized reader list.

Each of the A-IoT devices 1402, 1404, 1406 may transmit an association complete message after storing the association information (e.g., at 1446). For example, the first A-IoT device 1402 may transmit a first association complete message 1448, the second A-IoT device 1404 may transmit a second association complete message 1450, and the Nth A-IoT device 1406 may transmit an Nth association complete message 1452. The reader 1408 may receive the association complete messages 1448, 1450, and 1452 and may transmit an RRC setup complete message 1454.

The group signaling (e.g., group query command 1414 and the group association request 1438) described with reference to FIG. 14 may reduce signaling overhead at the reader 1408 and the network node 1410. Considering typical massive IoT device scenarios, such reduction in signaling overhead may significantly improve network performance as the number of A-IoT devices increases. The group signaling may also reduce power consumption at the reader 1408. Therefore, if the reader 1408 is a battery powered wireless communication device, such as a UE, such group signaling may extend the battery life of the reader 1408 when supporting multiple A-IoT devices.

### A-IoT Device States

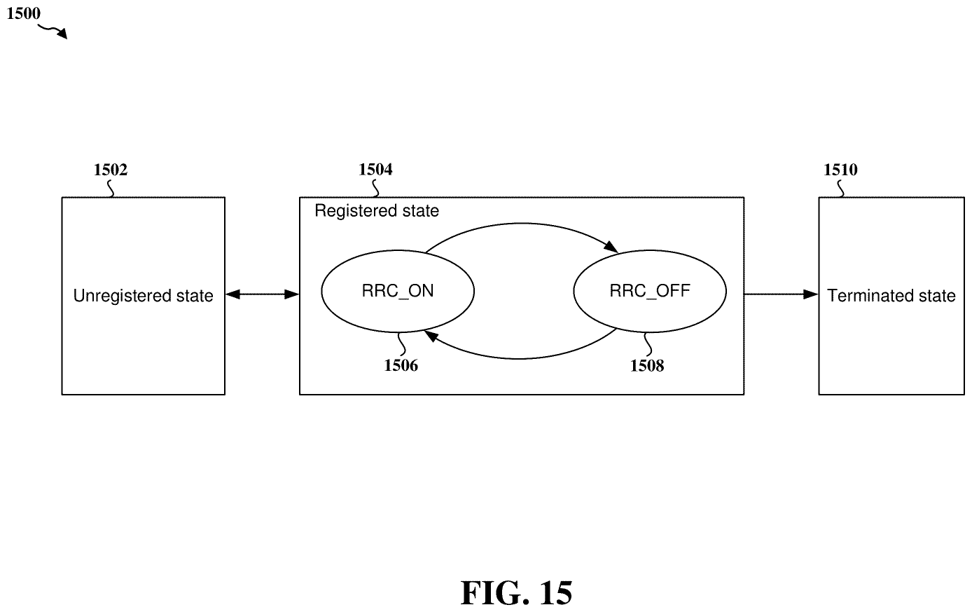

FIG. 15 is a diagram illustrating an example set of available states 1500 of an A-IoT device (e.g., A-IoT device 1202) as described herein. In some aspects, the A-IoT device may be in one of the set of available states 1500 at a given time.

As shown in FIG. 15, the set of available states 1500 may include an unregistered state 1502, a registered state 1504, and a terminated state 1510. In the unregistered state 1502, the A-IoT device is not registered to at least one mobile network entity (e.g., a 5G CN). In this state, the A-IoT device may be considered a new A-IoT device (also referred to as a new tag) from the perspective of a mobile network (e.g., a 5G NR network). After the A-IoT device has been identified and authorized to access the mobile network, the A-IoT device can transfer to the registered state 1504.

The set of available states 1500 may further include the registered state 1504. As previously described, the A-IoT device in this state has been identified and authorized access to a mobile network (e.g., a 5G NR network). Therefore, the A-IoT in this state has been assigned a unique tag ID (e.g., from a core network, such as the CN 1208) and an RNTI (e.g., a tag-RNTI) from a network node (e.g., a base station) for communications.

As shown in FIG. 15, the A-IoT device in the registered state 1504 may be in an RRC_ON mode 1506 or in an RRC_OFF mode 1508. In the RRC_ON mode 1506, the A-IoT device may receive a DL command or may backscatter data. In the RRC_OFF mode 1508, the A-IoT device is unable to receive and/or process DL signals and is unable to backscatter data. In some examples, the A-IoT device may transition to the RRC_OFF mode 1508 when harvesting energy.

The set of available states 1500 may further include a terminated state 1510. In some aspects, the A-IoT device may transition to the terminated state 1510 in response to a valid termination command. In the terminated state 1510, the A-IoT device is disabled. In some aspects, the terminated state 1510 may be permanent. In these aspects, transition to the terminated state 1510 is irreversible, such that the A-IoT device cannot transition to any other state from the terminated state 1510. For example, an A-IoT device in the terminated state 1510 cannot respond to any inventory message.

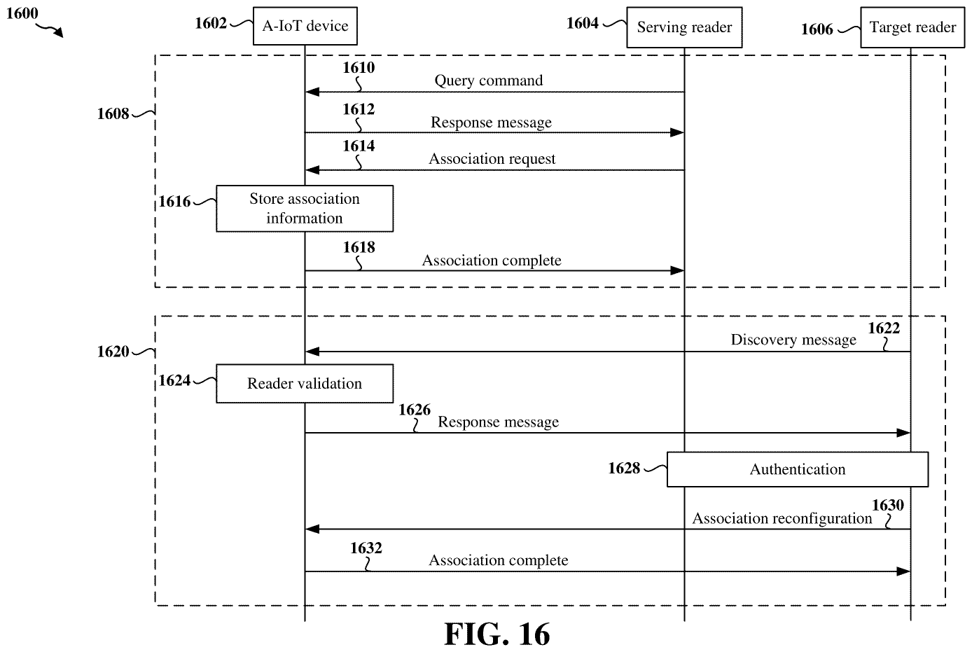

FIG. 16 illustrates a signal flow diagram 1600 in accordance with various aspects of the disclosure. FIG. 16 includes an A-IoT device 1602, a serving reader 1604, and a target reader 1606.

In FIG. 16, the A-IoT device 1602 may perform an initial association procedure 1608 to establish an association with the serving reader 1604. For example, the serving reader 1604 may transmit a query command 1610. The A-IoT device 1602 may receive the query command 1610 and may transmit a response message 1612. In some examples, the response message 1612 may include a unique tag ID associated with the A-IoT device 1602 and security information.

The serving reader 1604 may transmit an association request 1614 to associate the A-IoT device 1602 with the serving reader 1604. The association request 1614 may include a temporary identifier (e.g., tag-RNTI) for communication with a network node (e.g., a base station), a reader ID of the serving reader 1604, and an authorized reader list. At 1616, the A-IoT device 1602 may store association information based on the association request 1614. For example, the A-IoT device 1602 may store the tag-RNTI, the reader ID of the serving reader 1604, and the authorized reader list.

The A-IoT device 1602 may transmit an association complete message 1618 after storing the association information (e.g., at 1616). The serving reader 1604 may receive the association complete message 1618. Thereafter, if the A-IoT device 1602 receives a query command from the serving reader 1604, the A-IoT device 1602 may transmit a response message including the reader ID of the serving reader 1604.

In FIG. 16, the target reader 1606 may perform a discovery procedure 1620 to discover the A-IoT device 1602 and establish an association with the target reader 1606. For example, the target reader 1606 may transmit a discovery message 1622. The discovery message may be a message requesting basic information from an A-IoT device (e.g., similar to a query command), but may additionally include the reader ID to indicate where the command is from. In some examples, after receiving a discovery message with the reader ID, the A-IoT device may be required to perform a reader ID validation from the authorized reader ID list. The A-IoT device 1602 may receive the discovery message 1622 and may obtain a reader ID of the target reader 1606 included in the discovery message 1622.

At 1624, the A-IoT device 1602 may perform a reader validation operation. In some examples, the A-IoT device 1602 may perform the reader validation operation by determining whether the reader ID of the target reader 1606 is included in the authorized reader list. If the reader ID of the target reader 1606 is included in the authorized reader list, the A-IoT device 1602 determines that target reader 1606 is valid and transmits a response message 1626. The response message 1626 may include the unique tag ID associated with the A-IoT device 1602, the reader ID of the serving reader 1604, and security information.

At 1628, the target reader 1606 communicates with the serving reader 1604 for authentication of the A-IoT device 1602 via a communication link, such as a sidelink or a Uu link. If authentication of the A-IoT device 1602 is successful at 1628, the target reader 1606 may transmit an association reconfiguration message 1630 including a new tag-RNTI, the reader ID of the target reader 1606 and a new reader list. The A-IoT device 1602 may switch from its association with the serving reader 1604 to an association with the target reader 1606 in response to the association reconfiguration message 1630. The A-IoT device 1602 may transmit an association complete message 1632 indicating that the A-IoT device 1602 has switched to the association with the target reader 1606.

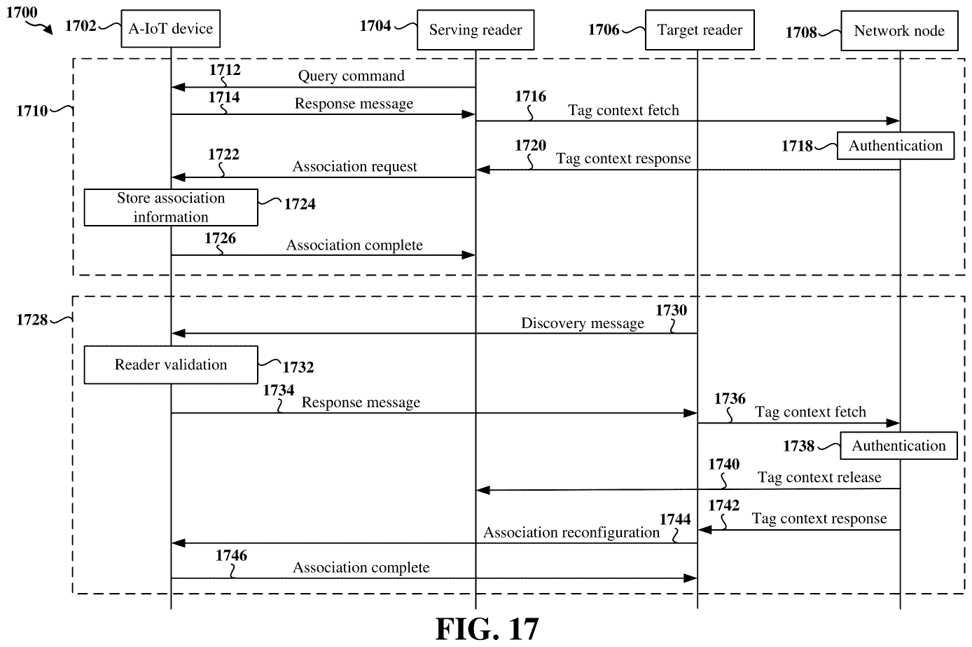

FIG. 17 illustrates a signal flow diagram 1700 in accordance with various aspects of the disclosure. FIG. 17 includes an A-IoT device 1702, a serving reader 1704, a target reader 1706, and a network node 1708. In some aspects, the network node 1708 may include one or more network nodes, such as a base station and/or a core network device.

In FIG. 17, the A-IoT device 1702 may perform an association procedure 1710 to establish an association with the serving reader 1704. For example, the serving reader 1704 may transmit a query command 1712. The A-IoT device 1702 may receive the query command 1712 and may transmit a response message 1714. In some examples, the response message 1714 may include a unique tag ID associated with the A-IoT device 1702 and security information.

The serving reader 1704 may transmit a tag context fetch message 1716 in response to the response message 1714. In some examples, the tag context fetch message 1716 may include the unique tag ID associated with the A-IoT device 1702. The network node 1708 may receive the tag context fetch message 1716.

In some aspects, the network node 1708 may be storing a tag context associated with the A-IoT device 1702 from a previous initial access procedure and connection setup performed for the A-IoT device 1702. At 1718, the network node 1708 may perform an authentication operation for the A-IoT device 1702 based on the unique tag ID associated with the A-IoT device 1702. The network node 1708 may transmit a tag context response message 1720 including the result of the authentication operation. For example, if the authentication operation at 1718 is successful, the tag context response message 1720 may include a temporary identifier (e.g., tag-RNTI) for communication with the network node 1708, the unique tag ID of the A-IoT device 1702, and an authorized reader list.

The serving reader 1704 may transmit an association request 1722 to associate the A-IoT device 1702 with the serving reader 1704. The association request 1722 may include a temporary identifier (e.g., tag-RNTI) for communication with a network node (e.g., a base station), a reader ID of the serving reader 1704, and the authorized reader list. At 1724, the A-IoT device 1702 may store association information based on the association request 1722. For example, the A-IoT device 1702 may store the tag-RNTI, the reader ID of the serving reader 1704, and the authorized reader list.

The A-IoT device 1702 may transmit an association complete message 1726 after storing the association information (e.g., at 1724). The serving reader 1704 may receive the association complete message 1726. Thereafter, if the A-IoT device 1702 receives a query command (e.g., from the serving reader 1704 or other reader), the A-IoT device 1702 may transmit a response message including the reader ID of the serving reader 1704.

In FIG. 17, the target reader 1706 may perform a discovery procedure 1728 to discover the A-IoT device 1702 and establish an association with the target reader 1706. For example, the target reader 1706 may transmit a discovery message 1730. The A-IoT device 1702 may receive the discovery message 1730 and may obtain a reader ID of the target reader 1706 included in the discovery message 1730.

At 1732, the A-IoT device 1702 may perform a reader validation operation. In some examples, the A-IoT device 1702 may perform the reader validation operation by determining whether the reader ID of the target reader 1706 is included in the authorized reader list. If the reader ID of the target reader 1706 is included in the authorized reader list, the A-IoT device 1702 determines that the target reader 1706 is valid and transmits a response message 1734. The response message 1734 may include the unique tag ID associated with the A-IoT device 1702, the reader ID of the serving reader 1704, and security information.

The target reader 1706 may transmit a tag context fetch message 1736 in response to the response message 1734. In some examples, the tag context fetch message 1736 may include the unique tag ID associated with the A-IoT device 1702. The network node 1708 may receive the tag context fetch message 1736.

At 1738, the network node 1708 may perform an authentication operation for the A-IoT device 1702 based on the unique tag ID associated with the A-IoT device 1702. The network node 1708 may transmit a tag context release message 1740 to the serving reader 1704 if the authentication operation at 1738 is successful.

The network node 1708 may transmit a tag context response message 1742 including the result of the authentication operation if the authentication operation at 1738 is successful. The tag context response message 1742 may include a temporary identifier (e.g., tag-RNTI) for communication with a network node (e.g., a base station), the unique tag ID of the A-IoT device 1702, and an authorized reader list.

The target reader 1706 may transmit an association reconfiguration message 1744 including a new tag-RNTI, the reader ID of the target reader 1706 and an authorized reader list. The A-IoT device 1702 may switch from its association with the serving reader 1704 to an association with the target reader 1706 in response to the association reconfiguration message 1744. The A-IoT device 1702 may transmit an association complete message 1746 indicating that the A-IoT device 1702 has switched to the association with the target reader 1706.

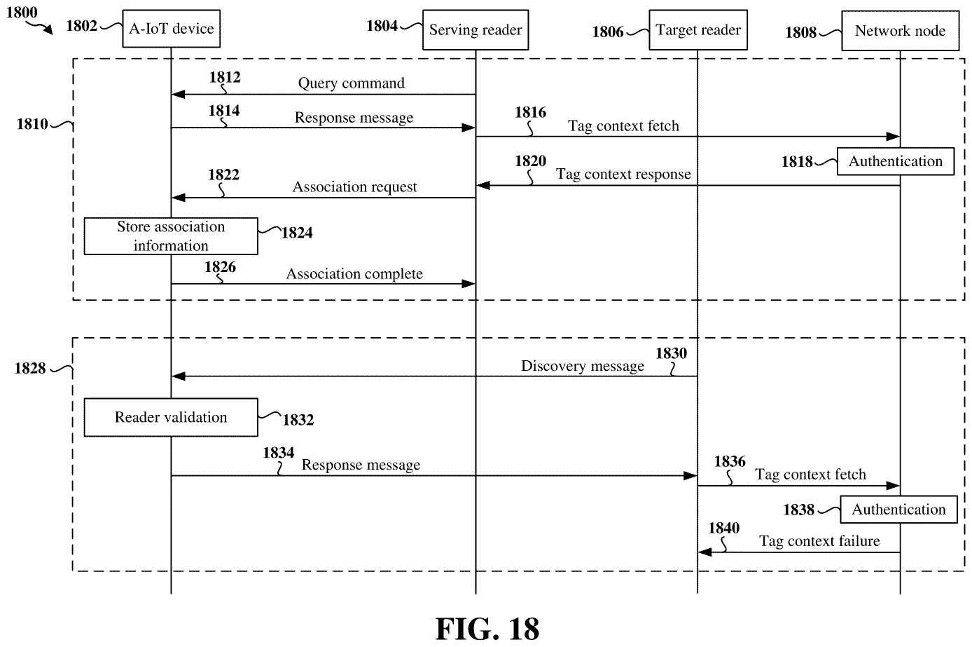

FIG. 18 illustrates a signal flow diagram 1800 in accordance with various aspects of the disclosure. FIG. 18 includes an A-IoT device 1802, a serving reader 1804, a target reader 1806, and a network node 1808. In some aspects, the network node 1808 may be a base station.

In FIG. 18, the A-IoT device 1802 may perform an association procedure 1810 to establish an association with the serving reader 1804. For example, the serving reader 1804 may transmit a query command 1812. The A-IoT device 1802 may receive the query command 1812 and may transmit a response message 1814. In some examples, the response message 1814 may include a unique tag ID associated with the A-IoT device 1802 and security information.

The serving reader 1804 may transmit a tag context fetch message 1816 in response to the response message 1814. In some examples, the tag context fetch message 1816 may include the unique tag ID associated with the A-IoT device 1802. The network node 1808 may receive the tag context fetch message 1816.

In some aspects, the network node 1808 may be storing a tag context associated with the A-IoT device 1802 from a previous initial access procedure and connection setup performed for the A-IoT device 1802. At 1818, the network node 1808 may perform an authentication operation for the A-IoT device 1802 based on the unique tag ID associated with the A-IoT device 1802. The network node 1808 may transmit a tag context response message 1820 including the result of the authentication operation. For example, if the authentication operation at 1818 is successful, the tag context response message 1820 may include a temporary identifier (e.g., tag-RNTI) for communication with the network node 1808, the unique tag ID of the A-IoT device 1802, and an authorized reader list.

The serving reader 1804 may transmit an association request 1822 to associate the A-IoT device 1802 with the serving reader 1804. The association request 1822 may include a temporary identifier (e.g., tag-RNTI) for communication with the network node 1808, a reader ID of the serving reader 1804, and the authorized reader list. At 1824, the A-IoT device 1802 may store association information based on the association request 1822. For example, the A-IoT device 1802 may store the tag-RNTI, the reader ID of the serving reader 1804, and the authorized reader list.

The A-IoT device 1802 may transmit an association complete message 1826 after storing the association information (e.g., at 1824). The serving reader 1804 may receive the association complete message 1826. Thereafter, if the A-IoT device 1802 receives a query command (e.g., from the serving reader 1804 or other reader), the A-IoT device 1802 may transmit a response message including the reader ID of the serving reader 1804.

In FIG. 18, the target reader 1806 may perform a discovery procedure 1828 to discover the A-IoT device 1802 and establish an association with the target reader 1806. For example, the target reader 1806 may transmit a discovery message 1830. The A-IoT device 1802 may receive the discovery message 1830 and may obtain a reader ID of the target reader 1806 included in the discovery message 1830.

At 1832, the A-IoT device 1802 may perform a reader validation operation. In some examples, the A-IoT device 1802 may perform the reader validation operation by determining whether the reader ID of the target reader 1806 is included in the authorized reader list. If the reader ID of the target reader 1806 is included in the authorized reader list, the A-IoT device 1802 determines that the target reader 1806 is valid and transmits a response message 1834. The response message 1834 may include the unique tag ID associated with the A-IoT device 1802, the reader ID of the serving reader 1804, and security information.

The target reader 1806 may transmit a tag context fetch message 1836 in response to the response message 1834. In some examples, the tag context fetch message 1836 may include the unique tag ID associated with the A-IoT device 1802. The network node 1808 may receive the tag context fetch message 1836.

At 1838, the network node 1808 may perform an authentication operation for the A-IoT device 1802 based on the unique tag ID associated with the A-IoT device 1802. If the authentication operation at 1838 is unsuccessful, the network node 1808 may not provide the tag context of the A-IoT device 1802 to the target reader 1806. In some examples, the network node 1808 may transmit a tag context failure message 1840, which may indicate to the target reader 1806 that the network node 1808 has refused to provide the tag context of the A-IoT device 1802. As a result, the target reader 1806 may not request an association with A-IoT device 1802. Therefore, in the example of FIG. 18, the A-IoT device 1802 may not switch from its association with the serving reader 1604 to an association with the target reader 160.

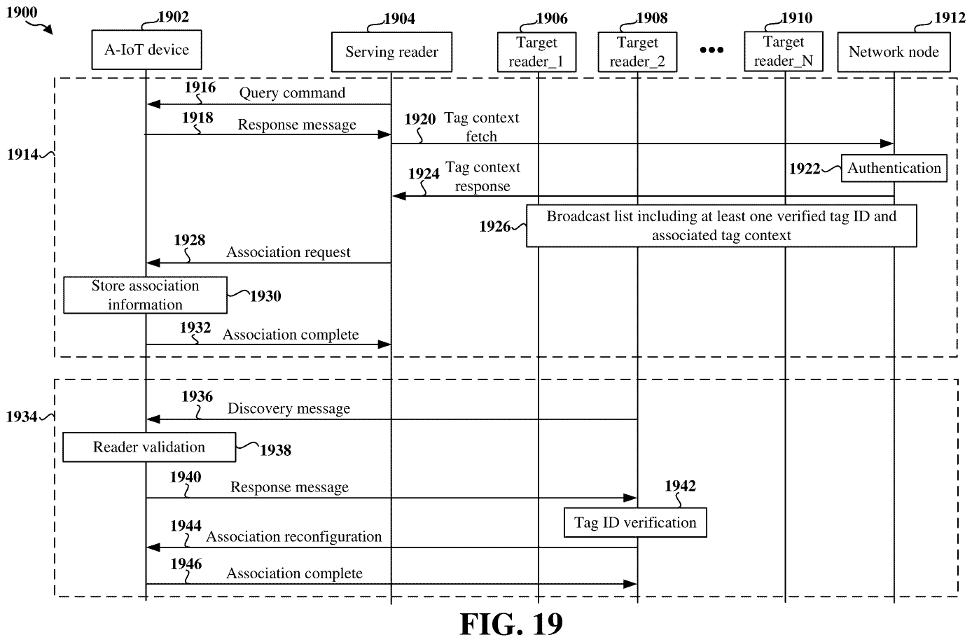

FIG. 19 illustrates a signal flow diagram 1900 in accordance with various aspects of the disclosure. FIG. 19 includes an A-IoT device 1902, a serving reader 1904, and multiple target readers, such as a first target reader 1906, a second target reader 1908, and an Nth target reader 1910 (e.g., where N is a positive integer), and a network node 1912. In some aspects, the network node 1912 may be a base station.

In FIG. 19, the A-IoT device 1902 may perform an association procedure 1914 to establish an association with the serving reader 1904. For example, the serving reader 1904 may transmit a query command 1916. The A-IoT device 1902 may receive the query command 1916 and may transmit a response message 1918. In some examples, the response message 1918 may include a unique tag ID associated with the A-IoT device 1902 and security information.

The serving reader 1904 may transmit a tag context fetch message 1920 in response to the response message 1918. In some examples, the tag context fetch message 1920 may include the unique tag ID associated with the A-IoT device 1902. The network node 1912 may receive the tag context fetch message 1920.

In some aspects, the network node 1912 may be storing a tag context associated with the A-IoT device 1902 from a previous initial access procedure and connection setup performed for the A-IoT device 1902. At 1922, the network node 1912 may perform an authentication operation for the A-IoT device 1902 based on the unique tag ID associated with the A-IoT device 1902. The network node 1912 may transmit a tag context response message 1924 including the result of the authentication operation. For example, if the authentication operation at 1922 is successful, the tag context response message 1924 may include a temporary identifier (e.g., tag-RNTI) for communication with the network node 1912, the unique tag ID of the A-IoT device 1902, and an authorized reader list.

At 1926, the network node 1912 may broadcast a list including at least one verified tag ID and an associated tag context to readers connected to the network node 1912. For example, the first target reader 1906, the second target reader 1908, and the Nth target reader 1910 may each receive the list including at least one verified tag ID and an associated tag context at 1926. In some examples, the network node 1912 may broadcast the list (e.g., at 1926) to readers associated with a certain tracking area.

The serving reader 1904 may transmit an association request 1928 to associate the A-IoT device 1902 with the serving reader 1904. The association request 1928 may include a temporary identifier (e.g., tag-RNTI) for communication with the network node 1912, a reader ID of the serving reader 1904, and the authorized reader list. At 1930, the A-IoT device 1902 may store association information based on the association request 1928. For example, the A-IoT device 1902 may store the tag-RNTI, the reader ID of the serving reader 1904, and the authorized reader list.

The A-IoT device 1902 may transmit an association complete message 1932 after storing the association information (e.g., at 1930). The serving reader 1904 may receive the association complete message 1932. Thereafter, if the A-IoT device 1902 receives a query command (e.g., from the serving reader 1904 or other reader), the A-IoT device 1902 may transmit a response message including the reader ID of the serving reader 1904.

In some aspects, one of the multiple target readers, such as the second target reader 1908, may perform a discovery procedure 1934 to discover the A-IoT device 1902 and establish an association with the second target reader 1908. For example, the second target reader 1908 may transmit a discovery message 1936. The A-IoT device 1902 may receive the discovery message 1936 and may obtain a reader ID of the second target reader 1986 included in the discovery message 1936.

At 1938, the A-IoT device 1902 may perform a reader validation operation. In some examples, the A-IoT device 1902 may perform the reader validation operation by determining whether the reader ID of the second target reader 1908 is included in the authorized reader list. If the reader ID of the second target reader 1908 is included in the authorized reader list, the A-IoT device 1902 determines that the second target reader 1908 is valid and transmits a response message 1940. The response message 1940 may include the unique tag ID associated with the A-IoT device 1902, the reader ID of the serving reader 1904, and security information.

At 1942, the second target reader 1908 may perform a tag ID verification operation for the A-IoT device 1902 based on the unique tag ID associated with the A-IoT device 1902. Since the second target reader 1908 has previously received a list (e.g., at 1926) including at least one verified tag ID and an associated tag context, the second target reader 1908 may perform the tag ID verification at 1942 by identifying the unique tag ID of the A-IoT device 1902 in the list. In other words, the second target reader 1908 may consider the unique tag ID of the A-IoT device 1902 valid if the unique tag ID is included in the list.

If the tag ID verification at 1942 is successful, the second target reader 1908 may transmit an association reconfiguration message 1944 including a new tag-RNTI, the reader ID of the second target reader 1908 and an authorized reader list. For example, the second target reader 1908 may obtain the new tag-RNTI for the A-IoT device 1902 from the list received at 1926. For example, if the second target reader 1908 identifies the unique tag ID of the A-IoT device 1902 in the list, the second target reader 1908 may obtain the new tag-RNTI from the tag context associated with the unique tag ID in the list.

The A-IoT device 1902 may switch from its association with the serving reader 1904 to an association with the second target reader 1908 in response to the association reconfiguration message 1944. The A-IoT device 1902 may transmit an association complete message 1946 indicating that the A-IoT device 1902 has switched to the association with the second target reader 1908.

In some aspects, if the second target reader 1908 cannot identify the unique tag ID of the A-IoT device 1902 in the list, the second target reader 1908 may transmit a tag context fetch message including the unique tag ID associated with the A-IoT device 1902. The network node 1912 may receive the tag context fetch message and may provide the tag context to the second target reader 1908 if the A-IoT device 1802 can be authenticated at the network node 1912 based on its unique tag ID.

It should be noted that the aspects described with reference to FIG. 19 enable a target reader (e.g., the second target reader 1908) to verify the tag ID of the A-IoT device 1902 at the target reader. For example, the previously received list (e.g., at 1926) including at least one verified tag ID and an associated tag context enables the second target reader 1908 to verify the tag ID of the A-IoT device 1902 and obtain the tag context of the A-IoT device 1902 without needing to transmit a tag context fetch message to the network node 1912 and wait for a response from the network node 1912. This may significantly reduce signaling overhead and association latency.

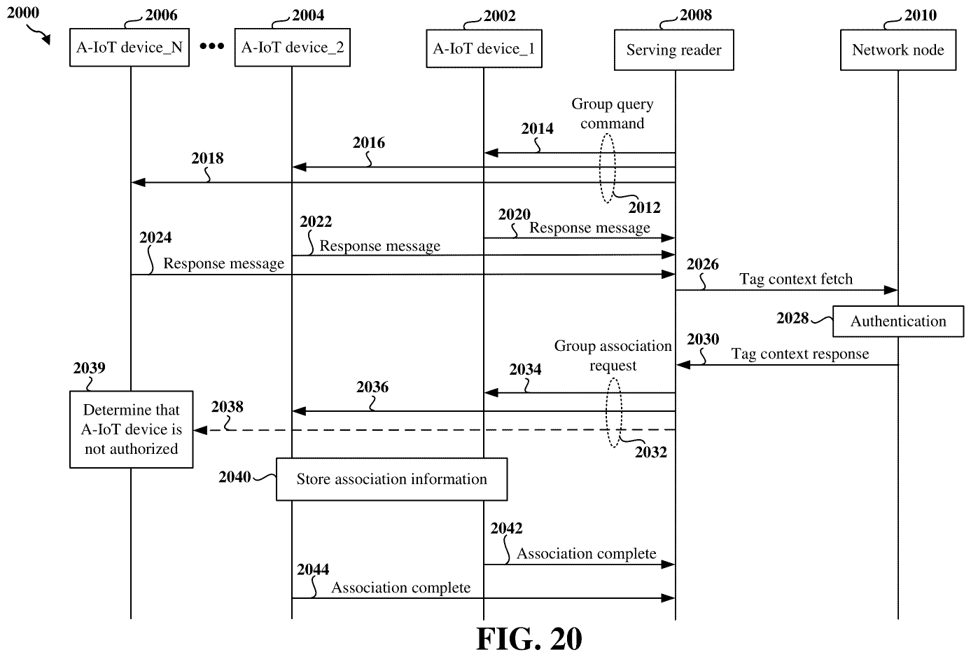

FIG. 20 is a signal flow diagram 2000 in accordance with various aspects of the disclosure. FIG. 20 includes multiple A-IoT devices, such as a first A-IoT device 2002, a second A-IoT device 2004, and an Nth A-IoT device 2006 (e.g., where N is a positive integer). FIG. 20 further includes a serving reader 2008, and a network node 2010. In some aspects, the network node 2010 may be a base station.

The serving reader 2008 may transmit a group query command 2012. In some aspects, the group query command 2012 may be included in one or more broadcast messages 2014, 2016, 2018 to the A-IoT devices 2002, 2004, 2006. In some examples, the group query command 2012 may be included in a single broadcast message that may be received at each of the A-IoT devices 2002, 2004, 2006.

In some examples, the group query command 2012 may include the identifiers (e.g., unique tag IDs assigned by the network node 2010) of the A-IoT devices 2002, 2004, 2006. For example, the group query command 2012 may include a first unique tag ID associated with the first A-IoT device 2002, a second unique tag ID associated with the second A-IoT device 2004, and so on.

Each of the A-IoT devices 2002, 2004, 2006 may transmit a response message in response to the group query command 2012. For example, the first A-IoT device 2002 may transmit a first response message 2020, the second A-IoT device 2004 may transmit a second response message 2022, and the Nth A-IoT device 2006 may transmit an Nth response message 2024. In some examples, each of the response messages 2020, 2022, 2024 may include the unique tag ID of the transmitting A-IoT device. For example, the first response message 2020 may include the unique tag ID of the first A-IoT device 2002, the second response message 2022 may include the unique tag ID of the second A-IoT device 2004, and the Nth response message 2024 may include the unique tag ID of the Nth A-IoT device 2006.

In some examples, one or more of the response messages 2020, 2022, 2024 may include a reader ID with a unique tag ID. In some examples, the reader ID may identify the reader from which an A-IoT device received its unique tag ID. In one example scenario, if each of the A-IoT devices 2002, 2004, 2006 previously received a unique tag ID from the serving reader 2008, each of the response messages 2020, 2022, 2024 may include the reader ID associated with the serving reader 2008.

In some examples, each of the response messages 2020, 2022, 2024 may include security information. For example, the first A-IoT device 2002 may include first security information in the response message 2020, the second A-IoT device 2004 may include second security information in the response message 2022, and the Nth A-IoT device 2006 may include Nth security information in the response message 2024.

The serving reader 2008 may transmit a tag context fetch message 2026 (also referred to as a group tag context fetch message) in response to the response messages 2020, 2022, 2024. In some aspects, the tag context fetch message 2026 may include multiple unique tag IDs of A-IoT devices (e.g., a set of unique tag IDs of A-IoT devices). For example, the tag context fetch message 2026 may include the unique tag ID of the first A-IoT device 2002, the unique tag ID of the second A-IoT device 2004, and the unique tag ID of the Nth A-IoT device 2006. The network node 2010 may receive the tag context fetch message 2026.

In some aspects, the network node 2010 may be storing a tag context for one or more of the A-IoT devices 2002, 2004, 2006 from a previous initial access procedures and connection setup operations performed for the A-IoT devices 2002, 2004, 2006. At 2028, the network node 2010 may perform an authentication operation for the A-IoT devices 2002, 2004, 2006 based on the unique tag IDs associated with the A-IoT devices 2002, 2004, 2006. The network node 2010 may transmit a tag context response message 2030 (also referred to as a group context response message) including the result of the authentication operation. For example, if the authentication operation at 2028 is successful, the tag context response message 2030 may include a temporary identifier for communication with the network node 2010, a set of unique tag IDs associated with authorized A-IoT devices, and an authorized reader list. For example, the temporary identifier may be an RNTI for the A-IoT devices 2002, 2004, 2006 (also referred to as a group tag-RNTI). The A-IoT devices 2002, 2004, 2006 may use the temporary identifier (e.g., group tag-RNTI) to monitor a physical (PHY) channel.

In some cases, the network node 2010 may determine that one or more of the A-IoT devices 2002, 2004, 2006 is not authorized to communicate with the serving reader 2008, the network node 2010, an application server, and/or other network entity coupled to the network node 2010. In these cases, the tag context response message 2030 may include a subset (also referred to as a partial set) of the multiple unique tag IDs of the A-IoT devices in the tag context fetch message 2026, where the subset includes tag IDs of authorized A-IoT devices and omits tag IDs of unauthorized A-IoT devices.

In FIG. 20, for example, the network node 2010 may determine that the Nth A-IoT device 2006 has failed the authentication operation at 2028 (e.g., the Nth A-IoT device 2006 is not authorized to communicate with the serving reader 2008, the network node 2010, and/or other network entity coupled to the network node 2010) and may omit its unique tag ID from the tag context response message 2030. Therefore, in this example, the tag context response message 2030 may include the unique tag IDs of the first and second A-IoT devices 2002, 2004 and may not include the unique tag ID of the Nth A-IoT device 2006.

The serving reader 2008 may transmit a group association request 2032 (also referred to as a group association request message) to associate the authorized A-IoT devices (e.g., the A-IoT devices 2002, 2004 in the example of FIG. 20) with the serving reader 2008. The group association request 2032 may include the temporary identifier (e.g., the group tag-RNTI), the reader ID, a list including one or more authorized readers (also referred to as an authorized reader list), and a group of unique tag IDs associated with the authorized A-IoT devices. For example, the group of unique tag IDs may include a subset (also referred to as a partial set) of the multiple unique tag IDs of the A-IoT devices in the tag context fetch message 2026, where the subset includes the unique tag IDs of the first and second A-IoT devices 2002, 2004 and omits the unique tag ID of the Nth A-IoT device 2006.

The A-IoT devices 2002, 2004, 2006 may receive the group association request 2032. In some aspects, the group association request 2032 may be included in one or more broadcast messages 2034, 2036, 2038 to the multiple A-IoT devices 2002, 2004, 2006. In some examples, the group association request 2032 may be included in a single broadcast message that may be received at each of the A-IoT devices 2002, 2004, 2006.

At 2039, the Nth A-IoT device 2006 may determine that it is not authorized to associate with the serving reader 2008. In some examples, the Nth A-IoT device 2006 may determine that it is not authorized to associate with the serving reader 2008 if the Nth A-IoT device 2006 determines that its unique tag ID is not included in the group association request 2032.

At 2040, each of the authorized A-IoT devices (e.g., A-IoT devices 2002, 2004) may store association information based on the group association request 2032. For example, each of the A-IoT devices 2002, 2004 may store the group tag-RNTI, the reader ID of the serving reader 2008, and the authorized reader list.

Each of the authorized A-IoT devices 2002, 2004 may transmit an association complete message after storing the association information (e.g., at 2040). For example, the first A-IoT device 2002 may transmit a first association complete message 2042, and the second A-IoT device 2004 may transmit a second association complete message 2044. The serving reader 2008 may receive the association complete messages 2042, 2044.

In FIG. 20, the tag context fetch message 2026 and the tag context response message 2030 in FIG. 20 may allow a serving reader to obtain the tag contexts for multiple A-IoT devices. Since the serving reader 2008 can obtain tag contexts for multiple A-IoT devices with a single tag context fetch message (e.g., tag context fetch message 2026) and a single tag context response message (e.g., tag context response message 2030), signaling overhead between the serving reader 2008 and the network node 2010 may be reduced. Considering typical massive IoT device scenarios, such reduction in signaling overhead may significantly improve network performance as the number of A-IoT devices increases. The group signaling may also reduce power consumption at the serving reader 2008. Therefore, if the serving reader 2008 is a battery powered wireless communication device, such as a UE, such group signaling may extend the battery life of the serving reader 2008.

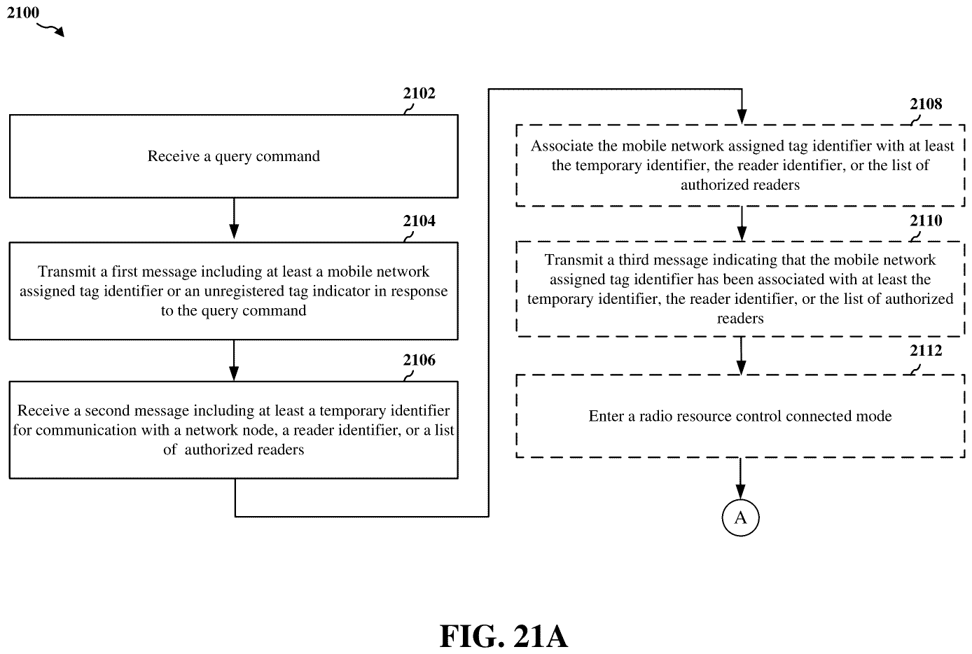

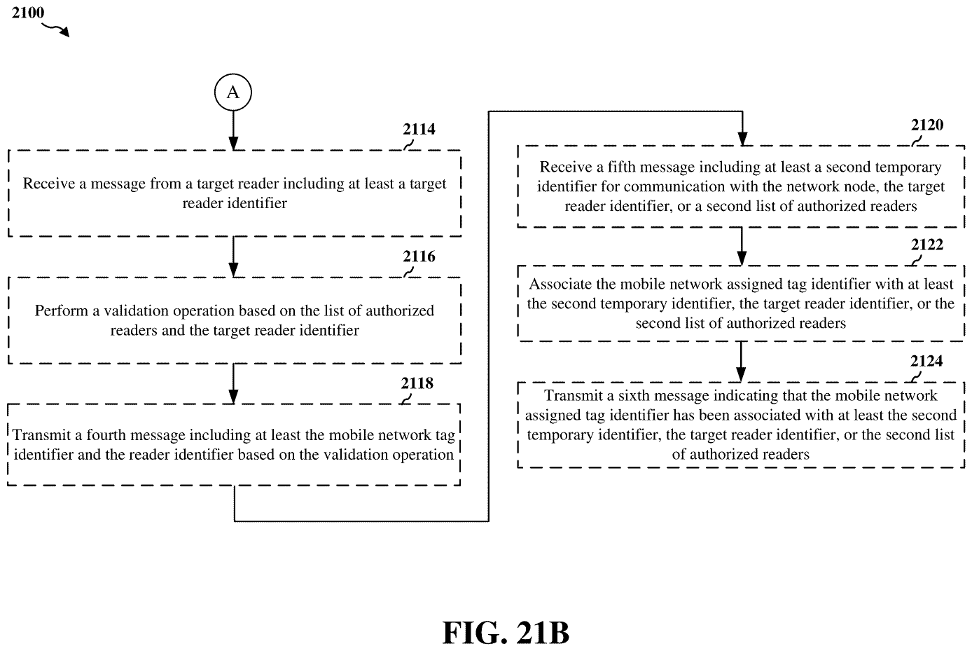

FIGS. 21A and 21B are a flowchart 2100 of a method of wireless communication. The method may be performed by an A-IoT device (e.g., the A-IoT device 105, 502, 1202, 1402, 1404, 1406, 1602, 1702, 1802, 1902, 2002, 2004, 2006; the apparatus 2302/2302′; the processing system 2414, which may include the memory 510 and which may be the entire A-IoT device or a component of the A-IoT device, such as the energy harvester 506 and/or the control circuit 508. In FIGS. 21A and 21B, blocks represented with dashed lines represent optional blocks.

At 2102, the A-IoT device receives a query command. For example, with reference to FIG. 12, the A-IoT device 1202 may receive the query command 1212. The query command may be a message requesting basic information from an A-IoT device, such as a tag ID.

At 2104, the A-IoT device transmits a first message including at least a mobile network assigned tag identifier or an unregistered tag indicator in response to the query command. The mobile network assigned tag identifier may be a unique tag ID assigned for an A-IoT device at a mobile network entity (e.g., the CN 1208). For example, with reference to FIG. 12, the A-IoT device 1202 may transmit a response message 1214 in response to the query command 1212. In some examples, the response message 1214 may include a unique tag ID previously assigned by a mobile network entity, such as the CN 1208.

At 2106, the A-IoT device receives a second message including at least a temporary identifier for communication with a network node, a reader identifier, or a list of authorized readers. In some aspects, the second message may be an association request from a reader. In some aspects, the second message includes the mobile network assigned tag identifier if the first message includes the unregistered tag indicator. For example, with reference to FIG. 12, the A-IoT device 1202 may receive an association request 1226 to associate the A-IoT device 1202 with the reader 1204. The association request 1226 may include the temporary identifier (e.g., tag-RNTI), the reader ID, and a list including one or more authorized readers (also referred to as an authorized reader list). In some examples, the reader may obtain the unique tag ID from the RRC setup message 1224 and may include the unique tag ID in the association request 1226. In some examples, the A-IoT device 1202 is in one of a plurality of available states, wherein the plurality of available states includes at least an unregistered state, a registered state, and a terminated state.

At 2108, the A-IoT device associates the mobile network assigned tag identifier with at least the temporary identifier, the reader identifier, or the list of authorized readers. For example, with reference to FIG. 12, the A-IoT device 1202 may associate at least the unique tag ID to the reader ID in response to the association request 1226.

At 2110, the A-IoT device transmits a third message indicating that the mobile network assigned tag identifier has been associated with at least the temporary identifier, the reader identifier, or the list of authorized readers. In some aspects, the third message may be an association complete message. For example, the A-IoT device 1202 may transmit an association complete message 1228 after the A-IoT device 1202 has associated its unique tag ID with at least the temporary identifier, the reader identifier, or the list including one or more authorized readers.

At 2112, the A-IoT device enters a radio resource control (RRC) connected mode. For example, when the A-IoT device is in the RRC connected mode, the A-IoT device may be connected to a network node (e.g., via a reader, such as the reader 1204). Accordingly, radio resources may be allocated for the A-IoT device at the network node (e.g., the network node 1206 in FIG. 12).

At 2114, the A-IoT device receives a message from a target reader including at least a target reader identifier. In some examples, the message may be a discovery message. The discovery message may be a message requesting basic information from an A-IoT device (e.g., similar to a query command), but may additionally include the reader ID to indicate where the command is from. For example, with reference to FIG. 16, the A-IoT device 1602 receives the discovery message 1622 from the target reader 1606.

At 2116, the A-IoT device performs a validation operation based on the list of authorized readers and the target reader identifier. For example, with reference to FIG. 16, the A-IoT device 1602 may perform the reader validation operation at 1624 by determining whether the reader ID of the target reader 1606 is included in the authorized reader list. If the reader ID of the target reader 1606 is included in the authorized reader list, the A-IoT device 1602 determines that target reader 1606 is valid.

At 2118, the A-IoT device transmits a fourth message including at least the mobile network tag identifier and the reader identifier based on the validation operation. The fourth message may be a response message, such as the response message 1626 in FIG. 16. For example, the A-IoT device 1602 transmits the response message 1626 if the reader ID of the target reader 1606 is determined to be valid (e.g., at 1624 in FIG. 16). The response message 1626 may include the unique tag ID associated with the A-IoT device 1602, the reader ID of the serving reader 1604, and security information.

At 2120, the A-IoT device receives a fifth message including at least a second temporary identifier for communication with the network node, the target reader identifier, or a second list of authorized readers. For example, the fifth message may be an association reconfiguration message from a target reader, such as the association reconfiguration message 1630 from the target reader 1606. For example, the second temporary identifier for communication with the network node may be a new tag-RNTI for communication with a network node of the target reader.

At 2122, the A-IoT device associates the mobile network assigned tag identifier with at least the second temporary identifier, the target reader identifier, or the second list of authorized readers. For example, the A-IoT device 1602 may switch from its association with the serving reader 1604 to an association with the target reader 1606 in response to the association reconfiguration message 1630.

At 2124, the A-IoT device transmits a sixth message indicating that the mobile network assigned tag identifier has been associated with at least the second temporary identifier, the target reader identifier, or the second list of authorized readers. For example, the sixth message may be an association complete message, such as the association complete message 1632 in FIG. 16 indicating that the A-IoT device 1602 has switched to the association with the target reader 1606.

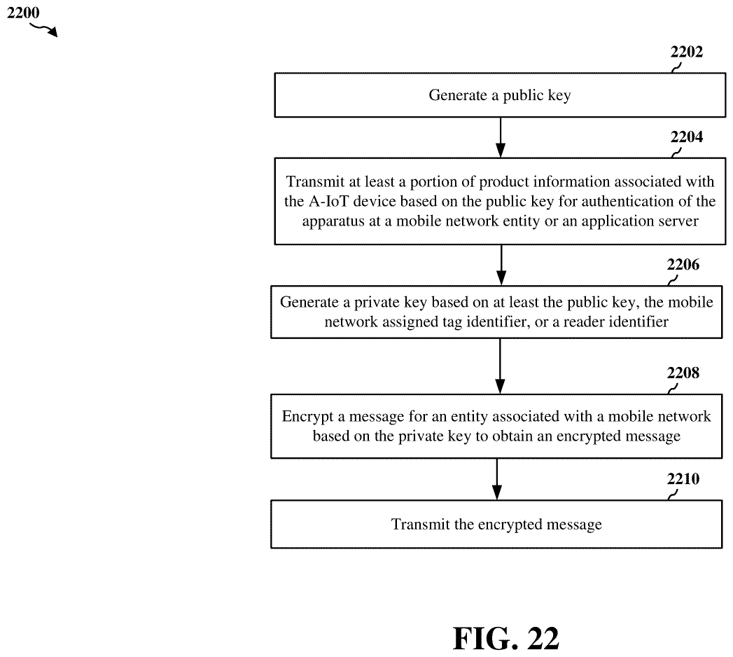

FIG. 22 is a flowchart 2200 of a method of wireless communication. The method may be performed by an A-IoT device (e.g., the A-IoT device 105, 502, 1202, 1402, 1404, 1406, 1602, 1702, 1802, 1902, 2002, 2004, 2006; the apparatus 2302/2302′; the processing system 2414, which may include the memory 510 and which may be the entire A-IoT device or a component of the A-IoT device, such as the energy harvester 506 and/or the control circuit 508.

At 2202, the A-IoT device generates a public key. In some examples, with reference to FIG. 12, the A-IoT device 1202 generates the public key based on a tag product ID, an electronic product code (EPC), and/or other product related information.

At 2204, the A-IoT device transmits at least a portion of product information associated with the A-IoT device based on the public key for authentication of the apparatus (e.g., at 1364, 1368 in FIG. 13) at a mobile network entity (e.g., the CN 1208) or an application server (e.g., the application server 1350). In some examples, the product information includes at least a tag product identifier or an electronic product code of the A-IoT device.

At 2206, the A-IoT device generates a private key based on at least the public key, the mobile network assigned tag identifier, or a reader identifier.

At 2208, the A-IoT device encrypts a message for an entity associated with a mobile network based on the private key to obtain an encrypted message.

At 2210, the A-IoT device transmits the encrypted message.

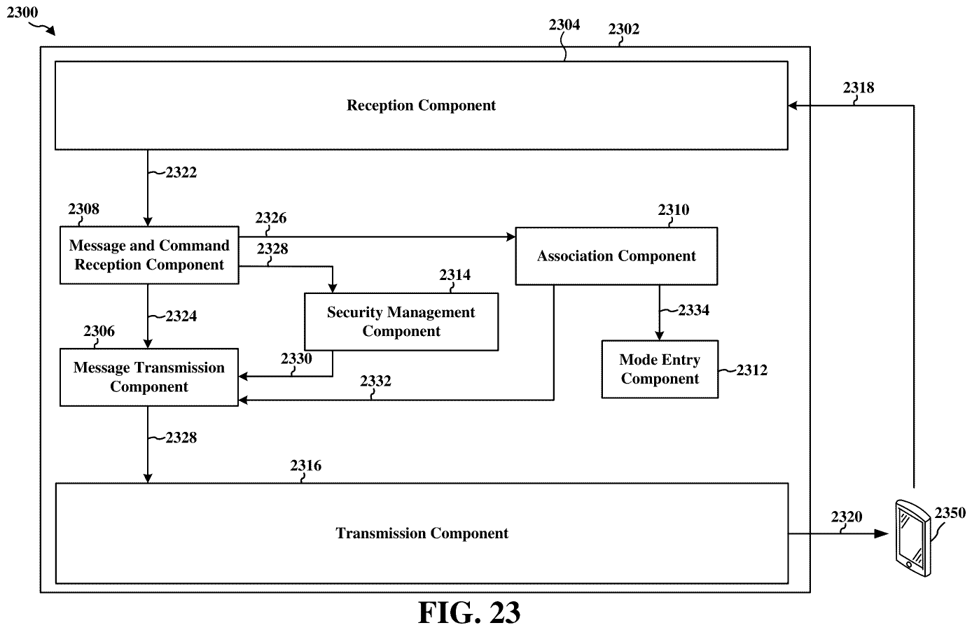

FIG. 23 is a conceptual data flow diagram 2300 illustrating the data flow between different means/components in an example apparatus 2302. The apparatus may be an A-IoT device. The apparatus 2302 may communicate with a reader 2350, such as a UE as described herein. The apparatus includes reception component 2304 that receives a signal 2318. The signal 2318 may include at least a forward link. In some examples, the signal 2318 may include a forward link and a continuous wave.

The apparatus further includes message transmission component 2306 that transmits (e.g., via the signals 2328, 2320 and the transmission component 2316) a first message including at least a mobile network assigned tag identifier or an unregistered tag indicator in response to the query command, transmits at least a portion of product information associated with the A-IoT device based on the public key for authentication of the apparatus at a mobile network entity or an application server, transmits a third message indicating that the mobile network assigned tag identifier has been associated with at least the temporary identifier, the reader identifier, or the list of authorized readers, transmits an encrypted message, transmits a fourth message including at least the mobile network tag identifier and the reader identifier based on the validation operation, and transmits a sixth message indicating that the mobile network assigned tag identifier has been associated with at least the second temporary identifier, the target reader identifier, or the second list of authorized readers.

In some aspects, the message transmission component 2306 receives a signal 2332 indicating that the mobile network assigned tag identifier has been associated with at least the temporary identifier, the reader identifier, or the list of authorized readers, or that the mobile network assigned tag identifier has been associated with at least the second temporary identifier, the target reader identifier, or the second list of authorized readers. The mode entry component 2312 may enter the radio resource control connected mode in response to the signal 2334. In some cases, the message transmission component 2306 receives a signal 2324, which may include information received at the message and command reception component 2308.

The apparatus further includes a message and command reception component 2308 that receives (e.g., via the signals 2318, 2322 and the reception component 2304) a receives a query command, a second message including at least a temporary identifier for communication with a network node, a reader identifier, or a list of authorized readers, receives a message from a target reader including at least a target reader identifier, and receives a fifth message including at least a second temporary identifier for communication with the network node, the target reader identifier, or a second list of authorized readers.

The apparatus further includes association component 2310 that associates the mobile network assigned tag identifier with at least the temporary identifier, the reader identifier, or the list of authorized readers, and associates the mobile network assigned tag identifier with at least the second temporary identifier, the target reader identifier, or the second list of authorized readers. For example, the association component 2310 may receive the temporary identifier, the reader identifier, and/or the list of authorized readers via the signal 2326 from the message and command reception component.

The apparatus further includes mode entry component 2312 that enters a radio resource control connected mode. In some aspects, the mode entry component 2312 receives a signal 2334 indicating that the mobile network assigned tag identifier has been associated with at least the temporary identifier, the reader identifier, or the list of authorized readers, or that the mobile network assigned tag identifier has been associated with at least the second temporary identifier, the target reader identifier, or the second list of authorized readers. The mode entry component 2312 may enter the radio resource control connected mode in response to the signal 2334.

The apparatus further includes security management component 2314 that generates a public key, generates a private key based on at least the public key, the mobile network assigned tag identifier, or a reader identifier, encrypts a message for an entity associated with a mobile network based on the private key to obtain an encrypted message, performs a validation operation based on the list of authorized readers and the target reader identifier. In some examples, security management component 2314 may decrypt an encrypted message received via signal 2328, or may encrypt a message for transmission and may provide the encrypted message via the signal 2330.

The apparatus further includes transmission component 2316 that transmits a signal 2320. The signal 2320 may include a backscatter link (e.g., a modulated backscatter signal).

The apparatus may include additional components that perform each of the blocks of the algorithm in the aforementioned flowcharts of FIGS. 21A, 21B, 22. As such, each block in the aforementioned flowcharts of FIGs. FIGS. 21A, 21B, 22 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

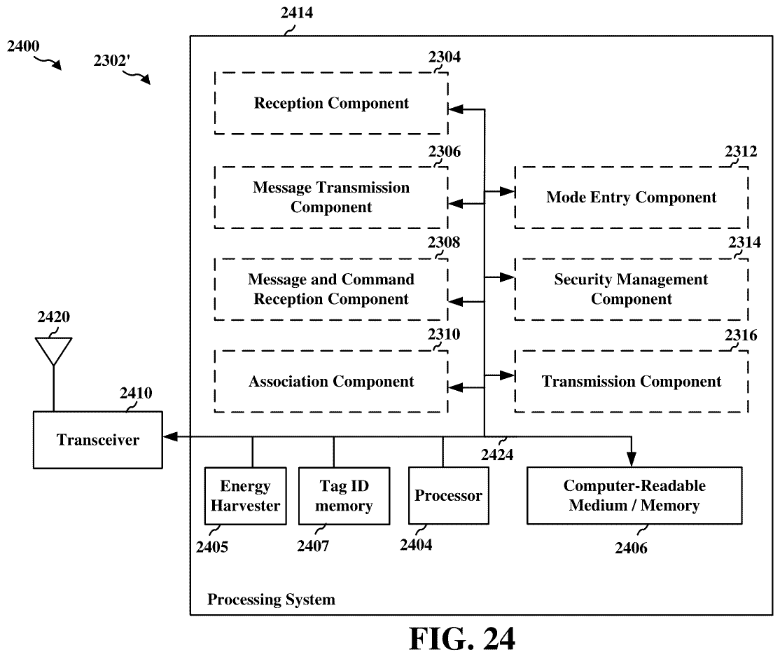

FIG. 24 is a diagram 2400 illustrating an example of a hardware implementation for an apparatus 2302′ employing a processing system 2414. The processing system 2414 may be implemented with a bus architecture, represented generally by the bus 2424. The bus 2424 may include any number of interconnecting buses and bridges depending on the specific application of the processing system 2414 and the overall design constraints. The bus 2424 links together various circuits including one or more processors and/or hardware components, represented by the processor 2404, the components 2304, 2306, 2308, 2310, 2312, 2314, 2316 and the computer-readable medium/memory 2406. The bus 2424 may also link various other circuits such as timing sources, peripherals, voltage regulators, power management circuits (e.g., which may include the energy harvester 2405), which are well known in the art, and therefore, will not be described any further. The bus 2424 may further link a tag ID (TID) memory 2407 for storing an identifier assigned by a manufacturer or vendor of the tag (e.g., of the A-IoT device).

The processing system 2414 may be coupled to a transceiver 2410. The transceiver 2410 is coupled to one or more antennas 2420. The transceiver 2410 provides a means for communicating with various other apparatus over a transmission medium. The transceiver 2410 receives a signal from the one or more antennas 2420, extracts information from the received signal, and provides the extracted information to the processing system 2414, specifically the reception component 2304. In addition, the transceiver 2410 receives information from the processing system 2414, specifically the transmission component 2316, and based on the received information, generates a signal (e.g., a modulated backscatter signal) to be applied to the one or more antennas 2420. The processing system 2414 includes a processor 2404 coupled to a computer-readable medium/memory 2406. The processor 2404 is responsible for general processing, including the execution of software stored on the computer-readable medium/memory 2406. The software, when executed by the processor 2404, causes the processing system 2414 to perform the various functions described supra for any particular apparatus. The computer-readable medium/memory 2406 may also be used for storing data that is manipulated by the processor 2404 when executing software. The processing system 2414 further includes at least one of the components 2304, 2306, 2308, 2310, 2312, 2314, 2316. The components may be software components running in the processor 2404, resident/stored in the computer readable medium/memory 2406, one or more hardware components coupled to the processor 2404, or some combination thereof. The processing system 2414 may be a component of the A-IoT device 502 and may include the memory 510 and/or the control circuit 508. Alternatively, the processing system 2414 may be the entire A-IoT device (e.g., see 502 of FIG. 5).

In one configuration, the apparatus 2302/2302′ for wireless communication includes means for receiving a query command, means for transmitting a first message including at least a mobile network assigned tag identifier or an unregistered tag indicator in response to the query command, means for receiving a second message including at least a temporary identifier for communication with a network node, a reader identifier, or a list of authorized readers, means for generating a public key, means for transmitting at least a portion of product information associated with the apparatus based on the public key for authentication of the apparatus at a mobile network entity or an application server, means for associating the mobile network assigned tag identifier with at least the temporary identifier, the reader identifier, or the list of authorized readers, means for transmitting a third message indicating that the mobile network assigned tag identifier has been associated with at least the temporary identifier, the reader identifier, or the list of authorized readers, means for entering a radio resource control connected mode, means for generating a private key based on at least the public key, the mobile network assigned tag identifier, or a reader identifier, means for encrypting a message for an entity associated with a mobile network based on the private key to obtain an encrypted message, means for transmitting the encrypted message, means for receiving a message from a target reader including at least a target reader identifier, means for performing a validation operation based on the list of authorized readers and the target reader identifier, means for transmitting a fourth message including at least the mobile network tag identifier and the reader identifier based on the validation operation, means for receiving a fifth message including at least a second temporary identifier for communication with the network node, the target reader identifier, or a second list of authorized readers, associates the mobile network assigned tag identifier with at least the second temporary identifier, the target reader identifier, or the second list of authorized readers, and means for transmitting a sixth message indicating that the mobile network assigned tag identifier has been associated with at least the second temporary identifier, the target reader identifier, or the second list of authorized readers.

The aforementioned means may be one or more of the aforementioned components of the apparatus 2302 and/or the processing system 2414 of the apparatus 2302′ configured to perform the functions recited by the aforementioned means. As described supra, the processing system 2414 may include the control circuit 508. As such, in one configuration, the aforementioned means may be the control circuit 508 configured to perform the functions recited by the aforementioned means.

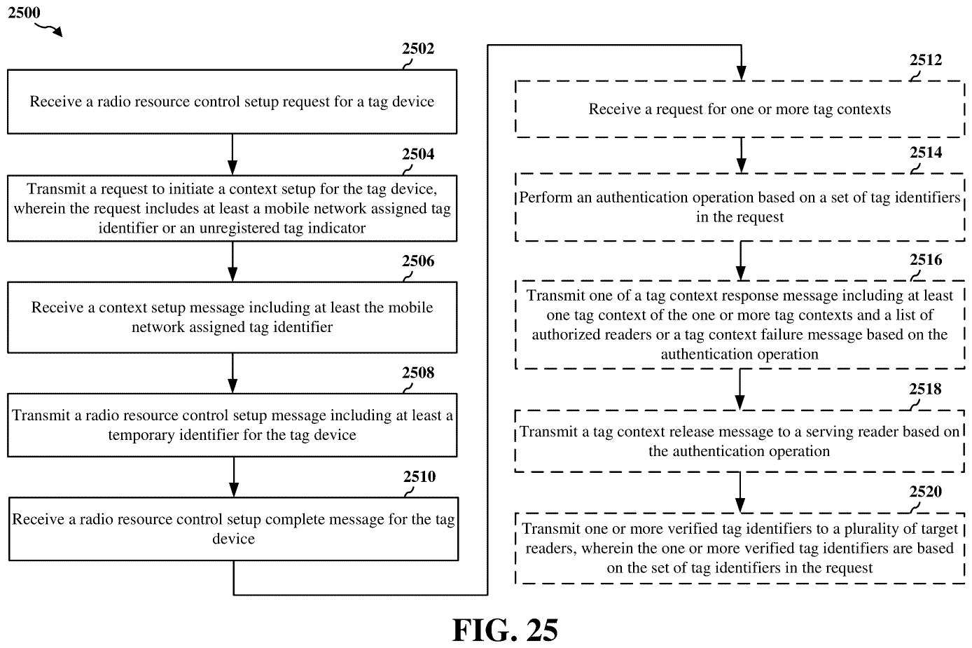

FIG. 25 is a flowchart 2500 of a method of wireless communication. The method may be performed by a network node (e.g., the base station 102, network node 1206, 1410, 1708, 1808, 1912, 2010; the apparatus 2602/2602′; the processing system 2714, which may include the memory 376 and which may be the entire network node or a component of the network node, such as the TX processor 316, the RX processor 370, and/or the controller/processor 375). In FIG. 25, blocks represented with dashed lines represent optional blocks.

At 2502, the network node receives a radio resource control setup request for a tag device. For example, with reference to FIG. 12, the network node 1206 may receive the RRC setup request 1216 from the reader 1204.

At 2504, the network node transmits a request to initiate a context setup for the tag device, wherein the request includes at least a mobile network assigned tag identifier or an unregistered tag indicator. In some examples, the request to initiate a context setup for the tag device may be the initiate tag context setup message 1218 described with reference to FIG. 12. For example, with reference to FIG. 12, the network node 1206 may attempt to identify the A-IoT device 1202 from the RRC setup request 1216. If the network node 1206 is unable to identify the A-IoT device 1202, the network node 1206 may transmit an initiate tag context setup message 1218. In some examples, the initiate tag context setup message 1218 may be configured to initiate a tag context setup procedure at the CN 1208.

At 2506, the network node receives a context setup message including at least the mobile network assigned tag identifier. For example, the context setup message may be the tag context setup message 1222. In some examples, the tag context setup message 1222 may include the unique tag ID of the A-IoT device 1202.

At 2508, the network node transmits a radio resource control (RRC) setup message including at least a temporary identifier for the tag device. For example, the RRC setup message may be the RRC setup message 1224 for the A-IoT device 1202 described with reference to FIG. 12. In some examples, the RRC setup message 1224 may include the unique tag ID. In some examples, the RRC setup message 1224 may include a temporary identifier. For example, the temporary identifier may be a tag-RNTI.

At 2510, the network node receives a radio resource control (RRC) setup complete message for the tag device. For example, the RRC setup complete message may be the RRC setup complete message 1230 in FIG. 12.

At 2512, the network node receives a request for one or more tag contexts. For example, the request for one or more tag contexts may be the tag context fetch message 1716, 1736, 1816, 1836, 1920, 2026 described herein.

At 2514, the network node performs an authentication operation based on a set of tag identifiers in the request. For example, the network node may perform the authentication operation at 1718, 1738, 1818, 1838, 1922, 2028 as described herein.

At 2516, the network node transmits one of a tag context response message including at least one tag context of the one or more tag contexts and a list of authorized readers or a tag context failure message based on the authentication operation. For example, the network node may transmit the tag context response message 1720, 1742, 1820, 1924, 2030. For example, the network node may transmit the tag context failure message 1840.

At 2518, the network node transmits a tag context release message to a serving reader based on the authentication operation. For example, the network node 1708 may transmit the tag context release message 1740 to the serving reader 1704 based on the authentication operation at 1738.

At 2520, the network node transmits one or more verified tag identifiers to a plurality of target readers, wherein the one or more verified tag identifiers are based on the set of tag identifiers in the request. For example, with reference to FIG. 19, at 1926, the network node 1912 may broadcast a list including at least one verified tag ID and an associated tag context to readers (e.g., the first target reader 1906, the second target reader 1908, and the Nth target reader 1910) connected to the network node 1912.

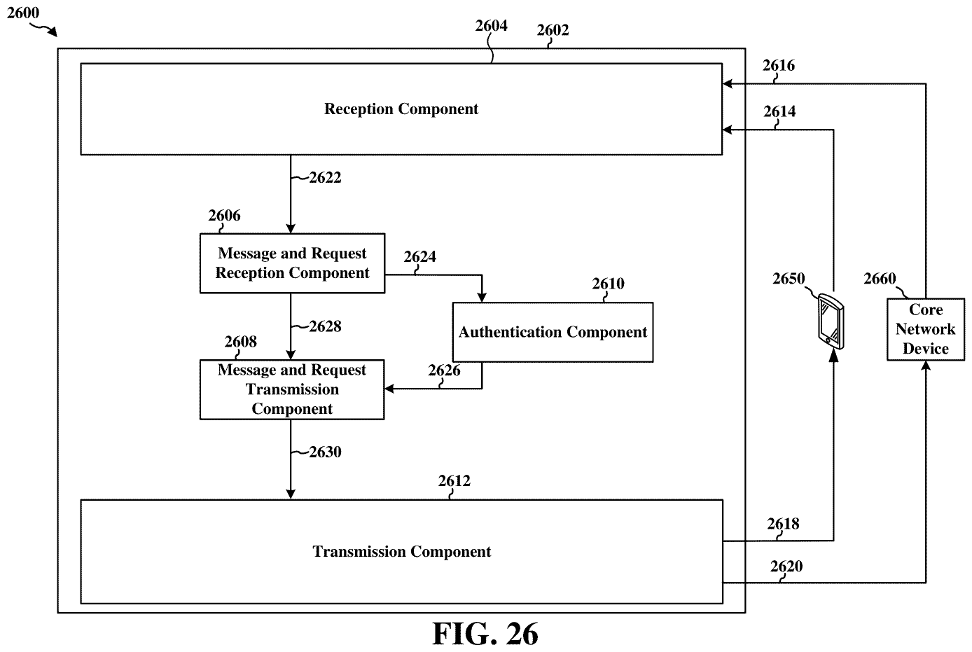

FIG. 26 is a conceptual data flow diagram 2600 illustrating the data flow between different means/components in an example apparatus 2602. The apparatus may be a network node. The network includes a reception component 2604 that receives a UL signal 2614 from a reader 2650 (e.g., a UE) and a signal 2616 from a core network device 2660.

The apparatus further includes a message and request reception component 2606 that receives (e.g., via the UL signal 2614 and the signal 2622) a radio resource control setup request for a tag device, receives (e.g., via the signal 2616 and the signal 2622) a context setup message including at least the mobile network assigned tag identifier, and receives (e.g., via the UL signal 2614 and the signal 2622) a radio resource control setup complete message for the tag device, receives (e.g., via the UL signal 2614 and the signal 2622) a request for one or more tag contexts.

The apparatus further includes a message and request transmission component 2608 that transmits (e.g., via the signal 2630 and the signal 2620) a request to initiate a context setup for the tag device, wherein the request includes at least a mobile network assigned tag identifier or an unregistered tag indicator, transmits (e.g., via the signal 2630 and the DL signal 2618) a radio resource control setup message including at least a temporary identifier for the tag device, transmits one of a tag context response message (e.g., via the signal 2630 and the DL signal 2618) including at least one tag context of the one or more tag contexts and a list of authorized readers or a tag context failure message based on the authentication operation, transmits (e.g., via the signal 2630 and the DL signal 2618) a tag context release message to a serving reader based on the authentication operation, transmits one or more verified tag identifiers to a plurality of target readers, wherein the one or more verified tag identifiers are based on the set of tag identifiers in the request. In some cases, the message and request transmission component 2608 receives a signal 2628, which may include information received at the message and request reception component 2606.

The apparatus further includes an authentication component 2610 that performs an authentication operation based on a set of tag identifiers in the request. For example, the authentication component 2610 may receive a request via the signal 2624 including a set of tag identifiers and may authenticate one or more of the set of tag identifiers. The authentication component 2610 may provide the result of the authentication operation via the signal 2626.

The apparatus further includes a transmission component 2612 that transmits a DL signal 2618 to the reader 2650 and a signal to the core network device 2660.

The apparatus may include additional components that perform each of the blocks of the algorithm in the aforementioned flowchart of FIG. 25. As such, each block in the aforementioned flowchart of FIG. 25 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

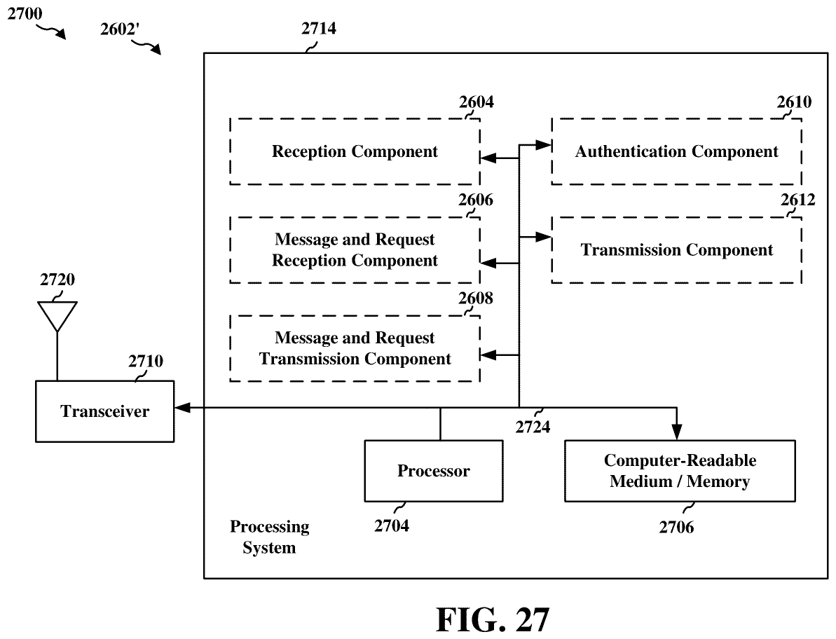

FIG. 27 is a diagram 2700 illustrating an example of a hardware implementation for an apparatus 2602′ employing a processing system 2714. The processing system 2714 may be implemented with a bus architecture, represented generally by the bus 2724. The bus 2724 may include any number of interconnecting buses and bridges depending on the specific application of the processing system 2714 and the overall design constraints. The bus 2724 links together various circuits including one or more processors and/or hardware components, represented by the processor 2704, the components 2604, 2606, 2608, 2610, 2612, and the computer-readable medium/memory 2706. The bus 2724 may also link various other circuits such as timing sources, peripherals, voltage regulators, and power management circuits, which are well known in the art, and therefore, will not be described any further.

The processing system 2714 may be coupled to a transceiver 2710. The transceiver 2710 is coupled to one or more antennas 2720. The transceiver 2710 provides a means for communicating with various other apparatus over a transmission medium. The transceiver 2710 receives a signal from the one or more antennas 2720, extracts information from the received signal, and provides the extracted information to the processing system 2714, specifically the reception component 2604. In addition, the transceiver 2710 receives information from the processing system 2714, specifically the transmission component 2612, and based on the received information, generates a signal to be applied to the one or more antennas 2720. The processing system 2714 includes a processor 2704 coupled to a computer-readable medium/memory 2706. The processor 2704 is responsible for general processing, including the execution of software stored on the computer-readable medium/memory 2706. The software, when executed by the processor 2704, causes the processing system 2714 to perform the various functions described supra for any particular apparatus. The computer-readable medium/memory 2706 may also be used for storing data that is manipulated by the processor 2704 when executing software. The processing system 2714 further includes at least one of the components 2604, 2606, 2608, 2610, 2612. The components may be software components running in the processor 2704, resident/stored in the computer readable medium/memory 2706, one or more hardware components coupled to the processor 2704, or some combination thereof. The processing system 2714 may be a component of the base station 310 and may include the memory 376 and/or at least one of the TX processor 316, the RX processor 370, and the controller/processor 375. Alternatively, the processing system 2714 may be the entire base station (e.g., see 310 of FIG. 3).

In one configuration, the apparatus 2602/2602′ for wireless communication includes means for receiving a radio resource control setup request for a tag device, means for transmitting a request to initiate a context setup for the tag device, wherein the request includes at least a mobile network assigned tag identifier or an unregistered tag indicator, means for receiving a context setup message including at least the mobile network assigned tag identifier, means for transmitting a radio resource control setup message including at least a temporary identifier for the tag device, means for receiving a radio resource control setup complete message for the tag device, means for receiving a request for one or more tag contexts, means for performing an authentication operation based on a set of tag identifiers in the request, means for transmitting one of a tag context response message including at least one tag context of the one or more tag contexts and a list of authorized readers or a tag context failure message based on the authentication operation, means for transmitting a tag context release message to a serving reader based on the authentication operation, means for transmitting one or more verified tag identifiers to a plurality of target readers, wherein the one or more verified tag identifiers are based on the set of tag identifiers in the request.

The aforementioned means may be one or more of the aforementioned components of the apparatus 2602 and/or the processing system 2714 of the apparatus 2602′ configured to perform the functions recited by the aforementioned means. As described supra, the processing system 2714 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

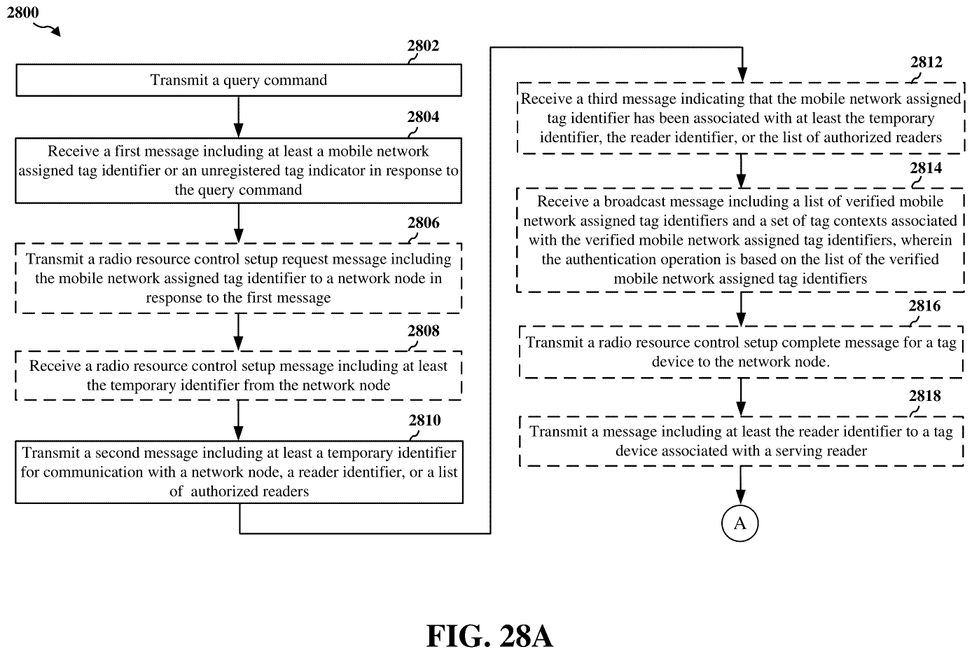

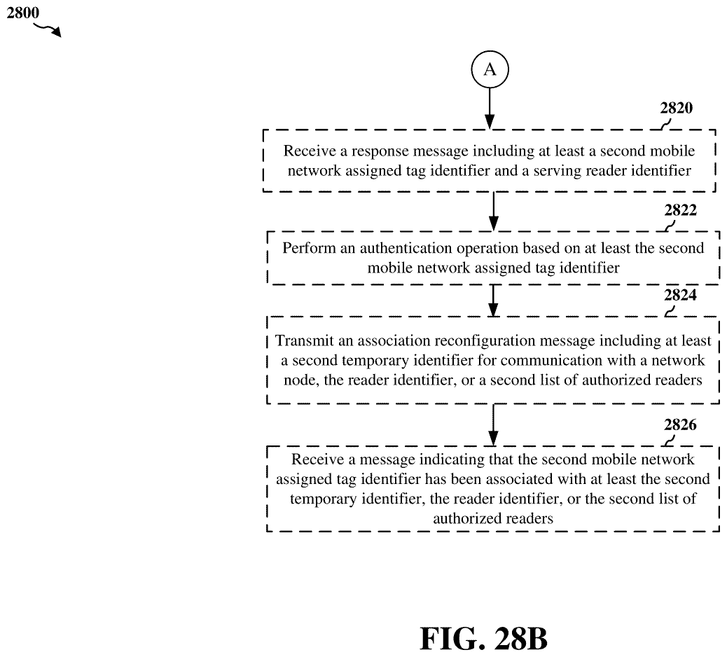

FIGS. 28A and 28B are a flowchart 2800 of a method of wireless communication. The method may be performed by a reader (e.g., the UE 104, the reader 504, 1204, 1408, 1604, 1606, 1704, 1706, 1804, 1806, 1904, 1906, 1908, 1910, 2008; the apparatus 3002/3002′; the processing system 3114, which may include the memory 360 and which may be the entire reader or a component of the reader. For example, if the reader is implemented as a UE (e.g., the UE 350), the aforementioned component of the reader may be the TX processor 368, the RX processor 356, and/or the controller/processor 359. In FIGS. 28A and 28B, blocks represented with dashed lines represent optional blocks.

With reference to FIG. 28A, at 2802, the reader transmits a query command. For example, with reference to FIG. 12, the reader 1204 may transmit a query command 1212.

At 2804, the reader receives a first message including at least a mobile network assigned tag identifier or an unregistered tag indicator in response to the query command. For example, with reference to FIG. 12, the reader 1204 may receive a response message 1214 in response to the query command 1212. In some examples, the response message 1214 may include a unique tag ID previously assigned by a mobile network entity, such as the CN 1208.

In some aspects, the query command is a group query command broadcast to multiple tag devices, and the first message is one of a set of messages from the plurality of tag devices based on the group query command.

At 2806, the reader transmits a radio resource control setup request message including the mobile network assigned tag identifier to a network node in response to the first message. For example, with reference to FIG. 12, the reader 1204 may transmit the RRC setup request 1216 to the network node 1206.

At 2808, the reader receives a radio resource control (RRC) setup message including at least the temporary identifier from the network node. For example, the RRC setup message may be the RRC setup message 1224 for the A-IoT device 1202 described with reference to FIG. 12. In some examples, the RRC setup message 1224 may include the unique tag ID. In some examples, the RRC setup message 1224 may include a temporary identifier. For example, the temporary identifier may be a tag-RNTI.

At 2810, the reader transmits a second message including at least a temporary identifier for communication with a network node, a reader identifier, or a list of authorized readers. For example, the second message may be an association request. With reference to FIG. 12, for example, the reader 1204 may transmit an association request 1226 to associate the A-IoT device 1202 with the reader 1204. The association request 1226 may include the temporary identifier (e.g., tag-RNTI), the reader ID, and a list including one or more authorized readers (also referred to as an authorized reader list). In some examples, the reader may obtain the unique tag ID from the RRC setup message 1224 and may include the unique tag ID in the association request 1226.

At 2812, the reader receives a third message indicating that the mobile network assigned tag identifier has been associated with at least the temporary identifier, the reader identifier, or the list of authorized readers. In some aspects, the third message may be an association complete message. For example, the A-IoT device 1202 may transmit an association complete message 1228 after the A-IoT device 1202 has associated its unique tag ID with at least the temporary identifier, the reader identifier, or the list including one or more authorized readers.

In some aspects, the second message is a group association request message broadcast to a plurality of tag devices, and the third message is one of a set of messages from the plurality of tag devices based on the group association request message.

At 2814, the reader receives a broadcast message including a list of verified mobile network assigned tag identifiers and a set of tag contexts associated with the verified mobile network assigned tag identifiers, wherein the authentication operation is based on the list of the verified mobile network assigned tag identifiers. For example, with reference to FIG. 19, at 1926, the network node 1912 may broadcast a list including at least one verified tag ID and an associated tag context to readers connected to the network node 1912. For example, the first target reader 1906, the second target reader 1908, and the Nth target reader 1910 may each receive the list including at least one verified tag ID and an associated tag context at 1926.

At 2816, the reader transmits a radio resource control (RRC) setup complete message for a tag device to the network node. For example, the RRC setup complete message may be the RRC setup complete message 1230 in FIG. 12.

At 2818, the reader transmits a message including at least the reader identifier to a tag device associated with a serving reader. In some examples, the message may be a discovery message. The discovery message may be a message requesting basic information from an A-IoT device (e.g., similar to a query command), but may additionally include the reader ID to indicate where the command is from. For example, with reference to FIG. 16, the target reader 1606 transmit the discovery message 1622 to the A-IoT device 1602.

With reference to FIG. 28B, at 2820, the reader receives a response message including at least a second mobile network assigned tag identifier and a serving reader identifier. For example, the target reader 1606 receives the response message 1626 if the reader ID of the target reader 1606 is determined to be valid (e.g., at 1624 in FIG. 16). The response message 1626 may include the unique tag ID associated with the A-IoT device 1602, the reader ID of the serving reader 1604, and security information.

At 2822, the reader performs an authentication operation based on at least the second mobile network assigned tag identifier.

At 2824, the reader transmits an association reconfiguration message including at least a second temporary identifier for communication with a network node, the reader identifier, or a second list of authorized readers. For example, the target reader 1606 may transmit the association reconfiguration message 1630. For example, the second temporary identifier for communication with the network node may be a new tag-RNTI for communication with a network node of the target reader.

At 2826, the reader receives a message indicating that the second mobile network assigned tag identifier has been associated with at least the second temporary identifier, the reader identifier, or the second list of authorized readers. For example, the message may be an association complete message, such as the association complete message 1632 in FIG. 16 indicating that the A-IoT device 1602 has switched to the association with the target reader 1606.

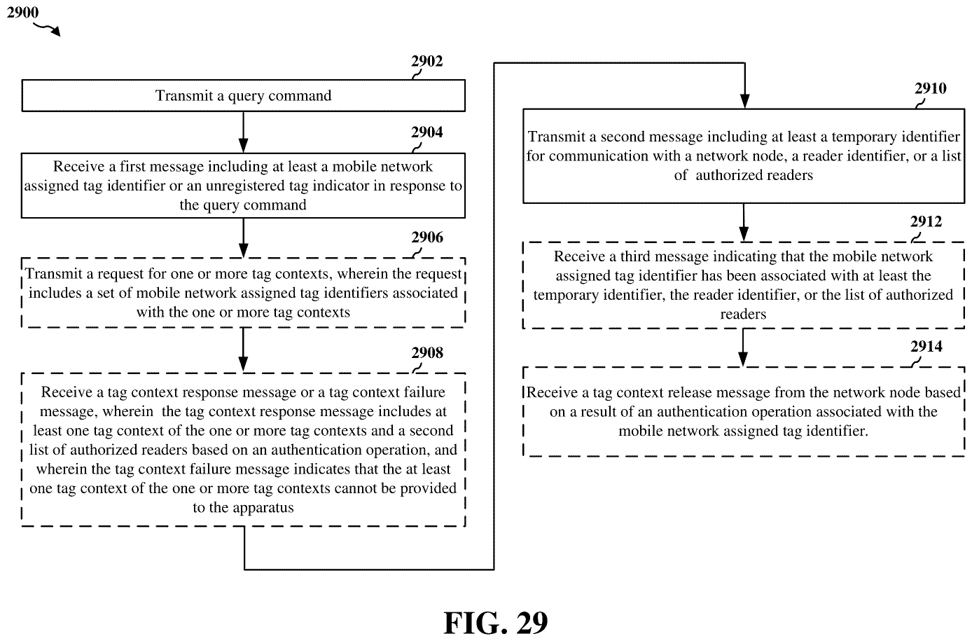

FIG. 29 is a flowchart 2900 of a method of wireless communication. The method may be performed by a reader (e.g., the UE 104, the reader 504, 1204, 1408, 1604, 1606, 1704, 1706, 1804, 1806, 1904, 1906, 1908, 1910, 2008; the apparatus 3002/3002′; the processing system 3114, which may include the memory 360 and which may be the entire reader or a component of the reader. For example, if the reader is implemented as a UE (e.g., the UE 350), the aforementioned component of the reader may be the TX processor 368, the RX processor 356, and/or the controller/processor 359. In FIG. 29, blocks represented with dashed lines represent optional blocks.

At 2902, the reader transmits a query command. For example, with reference to FIG. 17, the serving reader 1704 may transmit a query command 1712.

At 2904, the reader receives a first message including at least a mobile network assigned tag identifier or an unregistered tag indicator in response to the query command. In some examples, the first message may be the response message 1714, which may include a unique tag ID associated with the A-IoT device 1702 and security information.

At 2906, the reader transmits a request for one or more tag contexts, wherein the request includes a set of mobile network assigned tag identifiers associated with the one or more tag contexts. In some examples, the request for one or more tag contexts may be the tag context fetch message 1716. In some examples, the tag context fetch message 1716 may include the unique tag ID associated with the A-IoT device 1702.

At 2908, the reader receives a tag context response message or a tag context failure message, wherein the tag context response message includes at least one tag context of the one or more tag contexts and a second list of authorized readers based on an authentication operation, and wherein the tag context failure message indicates that the at least one tag context of the one or more tag contexts cannot be provided to the apparatus (e.g., the reader).

At 2910, the reader transmits a second message including at least a temporary identifier for communication with a network node, a reader identifier, or a list of authorized readers. In some examples, the second message may be an association request, such as the association request 1722 described with reference to FIG. 17. The association request 1722 may include a temporary identifier (e.g., tag-RNTI) for communication with a network node (e.g., a base station), a reader ID of the serving reader 1704, and the authorized reader list.

At 2912, the reader receives a third message indicating that the mobile network assigned tag identifier has been associated with at least the temporary identifier, the reader identifier, or the list of authorized readers. In some examples, the third message may be an association complete message, such as the association complete message 1726 described with reference to FIG. 17.

At 2914, the reader receives a tag context release message from the network node based on a result of an authentication operation associated with the mobile network assigned tag identifier. For example, the serving reader 1704 may receive the tag context release message 1740 if the authentication operation at 1738 is successful.

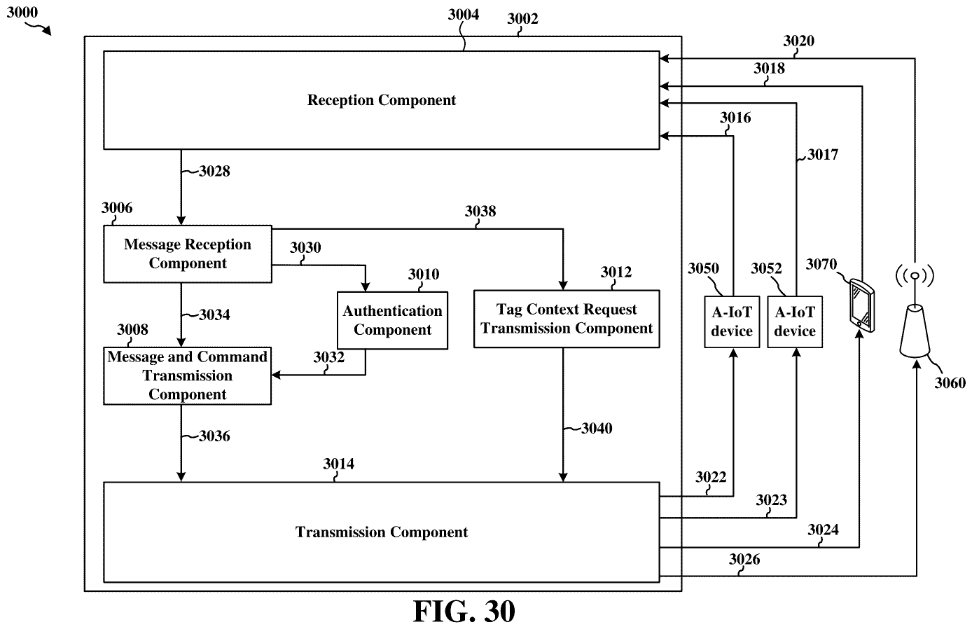

FIG. 30 is a conceptual data flow diagram 3000 illustrating the data flow between different means/components in an example apparatus 3002. The apparatus may be a reader (e.g., a UE).

The apparatus includes a reception component 3004 that receives a signal 3016 from a first A-IoT device 3050, a signal 3017 from a second A-IoT device 3052, a signal 3018 from a reader device 3070, and a DL signal 3020 from a network node. The signal 3016, 3017 may include a backscatter link (e.g., a modulated backscatter signal). The signal 3018 may be received through a sidelink or a Uu link.

The apparatus includes a message reception component 3006 that receives a first message (e.g., via the signal 3016 from the first A-IoT device 3050 and the signal 3028) including at least a mobile network assigned tag identifier or an unregistered tag indicator in response to the query command, receives a radio resource control setup message (e.g., via the DL signal 3020 from the network node 3060 and the signal 3028) including at least the temporary identifier from the network node, receives a third message (e.g., via the signal 3016 from the first A-IoT device 3050 and the signal 3028) indicating that the mobile network assigned tag identifier has been associated with at least the temporary identifier, the reader identifier, or the list of authorized readers, receives a broadcast message (e.g., via the DL signal 3020 from the network node 3060 and the signal 3028) including a list of verified mobile network assigned tag identifiers and a set of tag contexts associated with the verified mobile network assigned tag identifiers, receives a response message (e.g., via the signal 3017 from the second A-IoT device 3052 and the signal 3028) including at least a second mobile network assigned tag identifier and a serving reader identifier, receives a message (e.g., via the signal 3017 from the second A-IoT device 3052 and the signal 3028) indicating that the second mobile network assigned tag identifier has been associated with at least the second temporary identifier, the reader identifier, or the second list of authorized readers, receives a tag context response message or a tag context failure message (e.g., via the signal 3020 from the network node 3060 and the signal 3028), wherein the tag context response message includes at least one tag context of the one or more tag contexts and a second list of authorized readers based on an authentication operation, and wherein the tag context failure message indicates that the at least one tag context of the one or more tag contexts cannot be provided to the apparatus, receives a tag context release message from the network node 3060 (e.g., via the signal 3020 from the network node 3060 and the signal 3028) based on a result of an authentication operation associated with the mobile network assigned tag identifier. In some aspects, the message reception component 3006 may decrypt an encrypted message based on a private key.

The apparatus includes a message and command transmission component 3008 that transmits a query command (e.g., via the signal 3036 and the signal 3022), transmits a radio resource control setup request message (e.g., via the signal 3036 and the UL signal 3026) including the mobile network assigned tag identifier to the network node 3060 in response to the first message, transmits a second message (e.g., via the signal 3036 and the signal 3022) including at least a temporary identifier for communication with a network node, a reader identifier, or a list of authorized readers, transmits a radio resource control setup complete message (e.g., via the signal 3036 and the UL signal 3026) for a tag device to the network node 3060, transmits a message (e.g., via the signal 3036 and the signal 3023) including at least the reader identifier to a tag device (e.g., the second A-IoT device 3052) associated with a serving reader, transmits an association reconfiguration message (e.g., via the signal 3036 and the signal 3023) including at least a second temporary identifier for communication with a network node, the reader identifier, or a second list of authorized readers. In some aspects, the message and command transmission component 3008 may encrypt a message or command prior to transmission based on a private key. In some cases, the message and command transmission component 3008 receives a signal 3034, which may include information received at the message reception component 3006.

The apparatus includes an authentication component 3010 that performs an authentication operation based on at least the second mobile network assigned tag identifier. For example, the authentication component 3010 may receive a mobile network assigned tag identifier of the second A-IoT device 3052 via a signal 3030 from the message reception component and may perform an authentication operation based on the mobile network assigned tag identifier of the second A-IoT device 3052. The authentication component 3010 may provide a result of the authentication operation (e.g., success or failure) to the message and command transmission component 3008 via a signal 3032.

The apparatus includes a tag context request transmission component 3012 that transmits a request for one or more tag contexts (e.g., via the signal 3040 and the UL signal 3026), wherein the request includes a set of mobile network assigned tag identifiers associated with the one or more tag contexts. For example, the tag context request transmission component 3012 may transmits the request for one or more tag contexts in response to a signal 3038 including a set of mobile network assigned tag identifiers from the message reception component 3006.

The apparatus includes a transmission component 3014 that transmits a signal 3022 to the first A-IoT device 3050, a signal 3023 to the second A-IoT device 3052, a signal 3024 to the reader device 3070, and a UL signal 3026 to the network node 3060. In some examples, the signal 3022 may include at least a forward link. In some examples, the signal 3022 may include a continuous wave and a forward link. The signal 3024 may be transmitted through a sidelink or a Uu link.

The apparatus may include additional components that perform each of the blocks of the algorithm in the aforementioned flowcharts of FIGS. 28A, 28B, 29. As such, each block in the aforementioned flowcharts of FIGS. 28A, 28B, 29 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

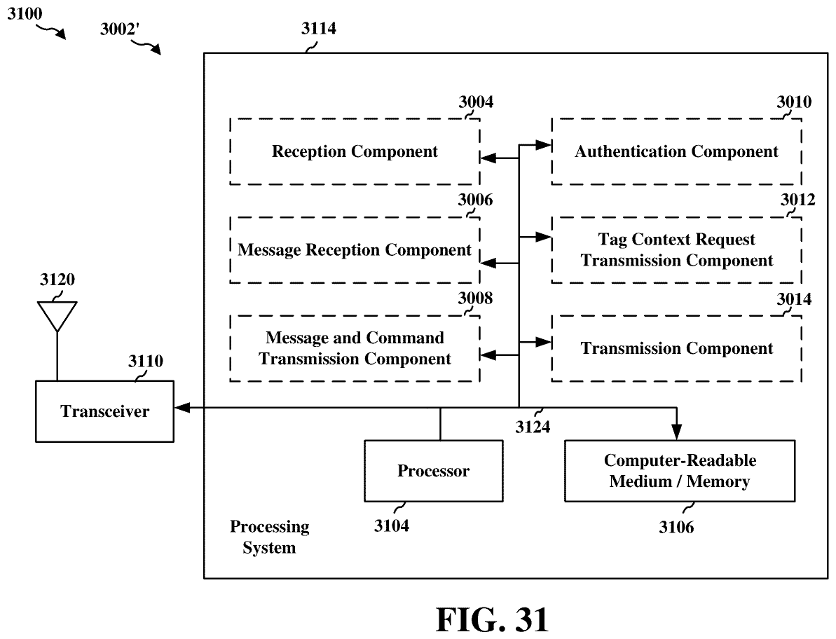

FIG. 31 is a diagram 3100 illustrating an example of a hardware implementation for an apparatus 3002′ employing a processing system 3114. The processing system 3114 may be implemented with a bus architecture, represented generally by the bus 3124. The bus 3124 may include any number of interconnecting buses and bridges depending on the specific application of the processing system 3114 and the overall design constraints. The bus 3124 links together various circuits including one or more processors and/or hardware components, represented by the processor 3104, the components 3004, 3006, 3008, 3010, 3012, 3014, and the computer-readable medium/memory 3106. The bus 3124 may also link various other circuits such as timing sources, peripherals, voltage regulators, and power management circuits, which are well known in the art, and therefore, will not be described any further.

The processing system 3114 may be coupled to a transceiver 3110. The transceiver 3110 is coupled to one or more antennas 3120. The transceiver 3110 provides a means for communicating with various other apparatus over a transmission medium. The transceiver 3110 receives a signal from the one or more antennas 3120, extracts information from the received signal, and provides the extracted information to the processing system 3114, specifically the reception component 3004. In addition, the transceiver 3110 receives information from the processing system 3114, specifically the transmission component 3014, and based on the received information, generates a signal to be applied to the one or more antennas 3120. The processing system 3114 includes a processor 3104 coupled to a computer-readable medium/memory 3106. The processor 3104 is responsible for general processing, including the execution of software stored on the computer-readable medium/memory 3106. The software, when executed by the processor 3104, causes the processing system 3114 to perform the various functions described supra for any particular apparatus. The computer-readable medium/memory 3106 may also be used for storing data that is manipulated by the processor 3104 when executing software. The processing system 3114 further includes at least one of the components 3004, 3006, 3008, 3010, 3012, 3014. The components may be software components running in the processor 3104, resident/stored in the computer readable medium/memory 3106, one or more hardware components coupled to the processor 3104, or some combination thereof. The processing system 3114 may be a component of the UE 350 and may include the memory 360 and/or at least one of the TX processor 368, the RX processor 356, and the controller/processor 359. Alternatively, the processing system 3114 may be the entire UE (e.g., see 350 of FIG. 3).

In one configuration, the apparatus 3002/3002′ for wireless communication includes means for transmitting a query command, means for receiving a first message including at least a mobile network assigned tag identifier or an unregistered tag indicator in response to the query command, means for transmitting a radio resource control setup request message including the mobile network assigned tag identifier to a network node in response to the first message, means for receiving a radio resource control setup message including at least the temporary identifier from the network node, means for transmitting a second message including at least a temporary identifier for communication with a network node, a reader identifier, or a list of authorized readers, means for receiving a third message indicating that the mobile network assigned tag identifier has been associated with at least the temporary identifier, the reader identifier, or the list of authorized readers, means for receiving a broadcast message including a list of verified mobile network assigned tag identifiers and a set of tag contexts associated with the verified mobile network assigned tag identifiers, wherein the authentication operation is based on the list of the verified mobile network assigned tag identifiers, means for transmitting a radio resource control setup complete message for a tag device to the network node, means for transmitting a message including at least the reader identifier to a tag device associated with a serving reader, means for receiving a response message including at least a second mobile network assigned tag identifier and a serving reader identifier, means for performing an authentication operation based on at least the second mobile network assigned tag identifier, means for transmitting an association reconfiguration message including at least a second temporary identifier for communication with a network node, the reader identifier, or a second list of authorized readers, means for receiving a message indicating that the second mobile network assigned tag identifier has been associated with at least the second temporary identifier, the reader identifier, or the second list of authorized readers, means for transmitting a request for one or more tag contexts, wherein the request includes a set of mobile network assigned tag identifiers associated with the one or more tag contexts, means for receiving a tag context response message or a tag context failure message, wherein the tag context response message includes at least one tag context of the one or more tag contexts and a second list of authorized readers based on an authentication operation, and wherein the tag context failure message indicates that the at least one tag context of the one or more tag contexts cannot be provided to the apparatus, means for receiving a tag context release message from the network node based on a result of an authentication operation associated with the mobile network assigned tag identifier.

The aforementioned means may be one or more of the aforementioned components of the apparatus 3002 and/or the processing system 3114 of the apparatus 3002′ configured to perform the functions recited by the aforementioned means. As described supra, the processing system 3114 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

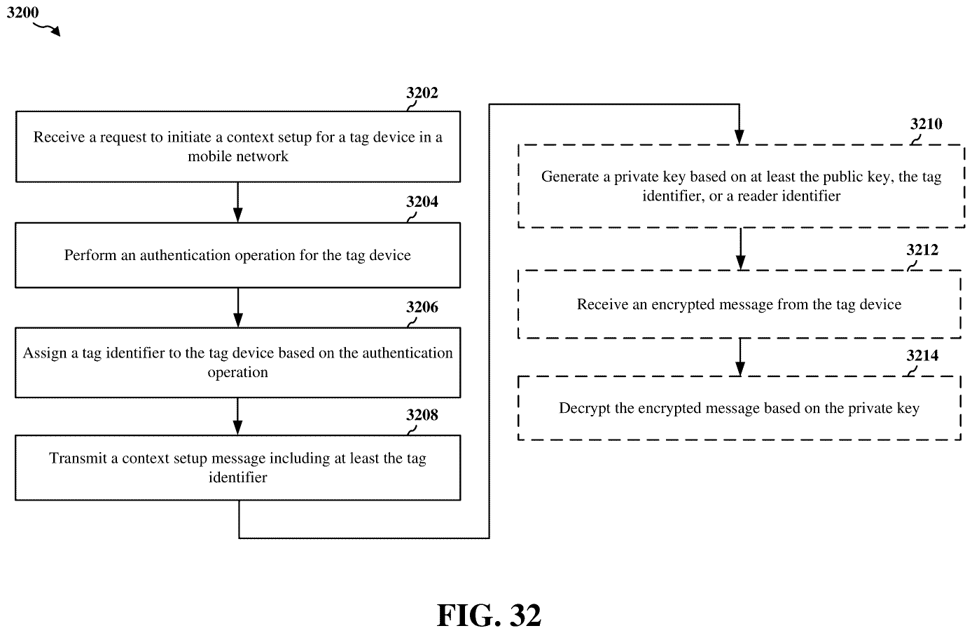

FIG. 32 is a flowchart 3200 of a method of wireless communication. The method may be performed by a core network device (e.g., the CN 1208, 1412; the apparatus 3302/3302′; the processing system 3414). In FIG. 32, blocks represented with dashed lines represent optional blocks.

At 3202, the core network device receives a request to initiate a context setup for a tag device in a mobile network. In some examples, the request to initiate a context setup for the tag device may be the initiate tag context setup message 1218 described with reference to FIG. 12. In some examples, the initiate tag context setup message 1218 may be configured to initiate a tag context setup procedure at the core network device (e.g., the CN 1208).

At 3204, the core network device performs an authentication operation for the tag device. For example, with reference to FIG. 12, the CN 1208 may perform an authentication procedure 1220 in response to the initiate tag context setup message 1218. An example of the authentication procedure 1220 is described herein with reference to FIG. 13.

At 3206, the core network device assigns a tag identifier to the tag device based on the authentication operation. In some examples, the authentication procedure 1220 may allow the CN 1208 to register the A-IoT device 1202. For example, the CN 1208 may perform the authentication procedure 1220 with the A-IoT device 1202 to generate and assign a unique tag ID for the A-IoT device 1202. For example, the CN 1208 may generate and assign a unique tag ID for the A-IoT device 1202 if the authentication procedure 1220 is successful. In the aspects described herein, the A-IoT device 1202 may be considered registered at the CN 1208 when a unique tag ID has been assigned to the A-IoT device 1202.

At 3208, the core network device transmits a context setup message including at least the tag identifier. For example, the CN 1208 may transmit a tag context setup message 1222 after completing the authentication procedure 1220. In some examples, the tag context setup message 1222 may include the unique tag ID of the A-IoT 1202.

At 3210, the core network device generates a private key (e.g., at 1374) based on at least the public key, the tag identifier, or a reader identifier.

At 3212, the core network device receives an encrypted message from the tag device. For example, the CN 1208 may receive the encrypted message at 1240 in FIG. 12.

At 3214, the core network device decrypts (e.g., at 1242) the encrypted message based on the private key.

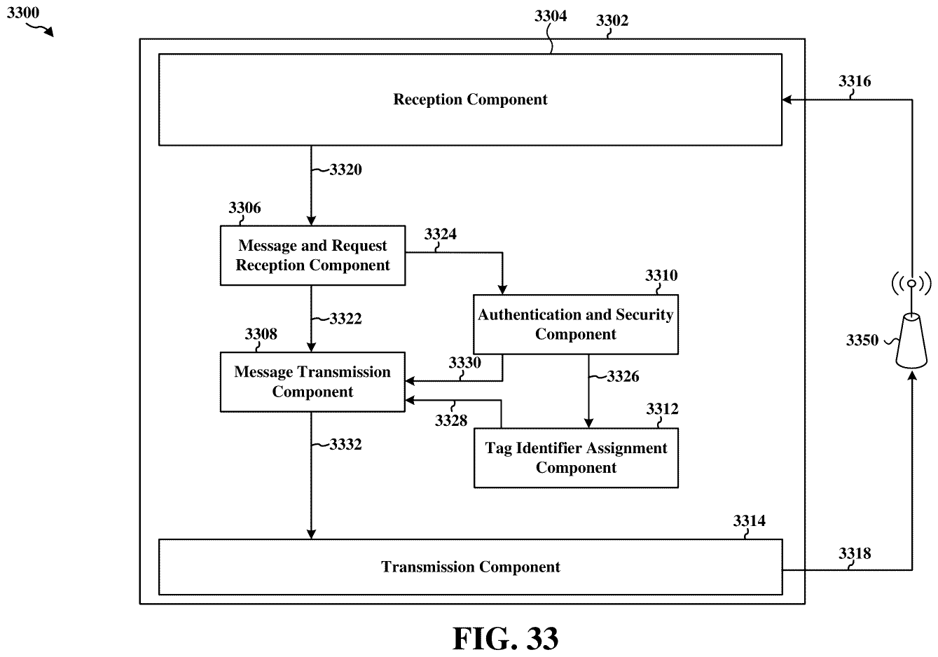

FIG. 33 is a conceptual data flow diagram 3300 illustrating the data flow between different means/components in an example apparatus 3302. The apparatus may be a core network device.

The apparatus includes a reception component 3304 that receives a signal 3316 from a network node 3350 (e.g., a base station).

The apparatus further includes a message and request reception component 3306 that receives a request (e.g., via a signal 3320 and the signal 3316) to initiate a context setup for a tag device in a mobile network and receives (e.g., via a signal 3320 and the signal 3316) an encrypted message from the tag device.

The apparatus further includes a message transmission component 3308 that transmits a context setup message (e.g., via a signal 3332 and the signal 3318) including at least the tag identifier. In some cases, the message transmission component 3308 receives a signal 3322, which may include information received at the message and request reception component 3306.

The apparatus further includes an authentication and security component 3310 that performs an authentication operation for the tag device, generates a private key based on at least the public key, the tag identifier, or a reader identifier, decrypts an encrypted message based on the private key, and encrypts a message (e.g., intended for an A-IoT device) based on the private key. For example, the authentication and security component 3310 may receive a message or a request from the message and request reception component via a signal 3324. For example, the authentication and security component 3310 may provide a result of an authentication operation (e.g., success or failure) to the tag identifier assignment component 3312 via a signal 3326 and/or to the message transmission component 3308 via a signal 3330.

The apparatus further includes a tag identifier assignment component 3312 that assigns a tag identifier to the tag device based on the authentication operation. For example, the tag identifier assignment component 3312 may receive the result of an authentication operation (e.g., success or failure) via the signal 3326 and may provide a tag identifier (e.g., a unique tag identifier for an A-IoT device) via a signal 3328 if the authentication operation is successful.

The apparatus further includes a transmission component 3314 that transmits a signal 3318 to the network node 3350.

The apparatus may include additional components that perform each of the blocks of the algorithm in the aforementioned flowchart of FIG. 32. As such, each block in the aforementioned flowchart of FIG. 32 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

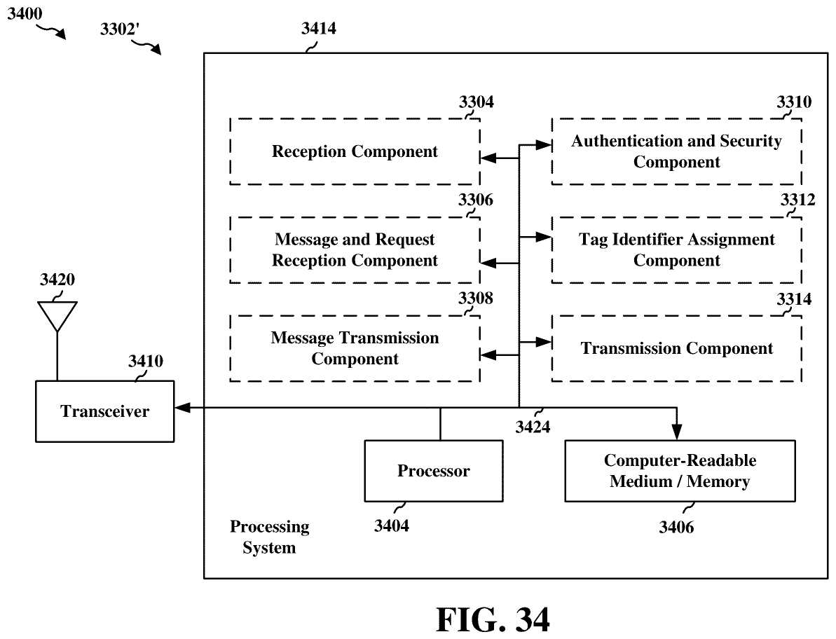

FIG. 34 is a diagram 3400 illustrating an example of a hardware implementation for an apparatus 3302′ employing a processing system 3414. The processing system 3414 may be implemented with a bus architecture, represented generally by the bus 3424. The bus 3424 may include any number of interconnecting buses and bridges depending on the specific application of the processing system 3414 and the overall design constraints. The bus 3424 links together various circuits including one or more processors and/or hardware components, represented by the processor 3404, the components 3304, 3306, 3308, 3310, 3312, 3314, and the computer-readable medium/memory 3406. The bus 3424 may also link various other circuits such as timing sources, peripherals, voltage regulators, and power management circuits, which are well known in the art, and therefore, will not be described any further.

The processing system 3414 may be coupled to a transceiver 3410. The transceiver 3410 is coupled to one or more antennas 3420. The transceiver 3410 provides a means for communicating with various other apparatus over a transmission medium. The transceiver 3410 receives a signal from the one or more antennas 3420, extracts information from the received signal, and provides the extracted information to the processing system 3414, specifically the reception component 3304. In addition, the transceiver 3410 receives information from the processing system 3414, specifically the transmission component 3314, and based on the received information, generates a signal to be applied to the one or more antennas 3420. The processing system 3414 includes a processor 3404 coupled to a computer-readable medium/memory 3406. The processor 3404 is responsible for general processing, including the execution of software stored on the computer-readable medium/memory 3406. The software, when executed by the processor 3404, causes the processing system 3414 to perform the various functions described supra for any particular apparatus. The computer-readable medium/memory 3406 may also be used for storing data that is manipulated by the processor 3404 when executing software. The processing system 3414 further includes at least one of the components 3304, 3306, 3308, 3310, 3312, 3314. The components may be software components running in the processor 3404, resident/stored in the computer readable medium/memory 3406, one or more hardware components coupled to the processor 3404, or some combination thereof. The processing system 3414 may be a component of the core network device. Alternatively, the processing system 3414 may be the entire core network device.

In one configuration, the apparatus 3302/3302′ for wireless communication includes means for receiving a request to initiate a context setup for a tag device in a mobile network, means for performing an authentication operation for the tag device, means for assigning a tag identifier to the tag device based on the authentication operation, means for transmitting a context setup message including at least the tag identifier, means for generating a private key based on at least the public key, the tag identifier, or a reader identifier, means for receiving an encrypted message from the tag device, and means for decrypting the encrypted message based on the private key. The aforementioned means may be one or more of the aforementioned components of the apparatus 3302 and/or the processing system 3414 of the apparatus 3302′ configured to perform the functions recited by the aforementioned means.

The following provides an overview of aspects of the present disclosure:

Aspect 1: An apparatus for wireless communication, comprising: a memory; and at least one processor coupled to the memory and configured to: receive a query command; transmit a first message including at least a mobile network assigned tag identifier or an unregistered tag indicator in response to the query command; and receive a second message including at least a temporary identifier for communication with a network node, a reader identifier, or a list of authorized readers.

Aspect 2: The apparatus of aspect 1, wherein the at least one processor is further configured to: associate the mobile network assigned tag identifier with at least the temporary identifier, the reader identifier, or the list of authorized readers; transmit a third message indicating that the mobile network assigned tag identifier has been associated with at least the temporary identifier, the reader identifier, or the list of authorized readers; and enter a radio resource control connected mode.

Aspect 3: The apparatus of aspect 1 or 2, wherein the second message includes the mobile network assigned tag identifier if the first message includes the unregistered tag indicator.

Aspect 4: The apparatus of any of aspects 1 through 3, wherein the apparatus is in one of a plurality of available states, wherein the plurality of available states includes at least an unregistered state, a registered state, and a terminated state.

Aspect 5: The apparatus of any of aspects 1 through 4, wherein the at least one processor is further configured to: generate a public key; and transmit at least a portion of product information associated with the apparatus based on the public key for authentication of the apparatus at a mobile network entity or an application server.

Aspect 6: The apparatus of any of aspects 1 through 5, wherein the product information includes at least a tag product identifier or an electronic product code.

Aspect 7: The apparatus of any of aspects 1 through 6, wherein the at least one processor is further configured to: generate a private key based on at least the public key, the mobile network assigned tag identifier, or a reader identifier; encrypt a message for an entity associated with a mobile network based on the private key to obtain an encrypted message; and transmit the encrypted message.

Aspect 8: The apparatus of any of aspects 1 through 7, wherein the at least one processor is further configured to: receive a message from a target reader including at least a target reader identifier; perform a validation operation based on the list of authorized readers and the target reader identifier; transmit a fourth message including at least the mobile network tag identifier and the reader identifier based on the validation operation; receive a fifth message including at least a second temporary identifier for communication with the network node, the target reader identifier, or a second list of authorized readers; associate the mobile network assigned tag identifier with at least the second temporary identifier, the target reader identifier, or the second list of authorized readers; and transmit a sixth message indicating that the mobile network assigned tag identifier has been associated with at least the second temporary identifier, the target reader identifier, or the second list of authorized readers.

Aspect 9: An apparatus for wireless communication, comprising: a memory; and at least one processor coupled to the memory and configured to: receive a radio resource control setup request for a tag device; transmit a request to initiate a context setup for the tag device, wherein the request includes at least a mobile network assigned tag identifier or an unregistered tag indicator; receive a context setup message including at least the mobile network assigned tag identifier; transmit a radio resource control setup message including at least a temporary identifier for the tag device; and receive a radio resource control setup complete message for the tag device.

Aspect 10: The apparatus of aspect 9, wherein the at least one processor is further configured to: receive a request for one or more tag contexts; perform an authentication operation based on a set of tag identifiers in the request; and transmit one of a tag context response message including at least one tag context of the one or more tag contexts and a list of authorized readers or a tag context failure message based on the authentication operation.

Aspect 11: The apparatus of aspect 9 or 10, wherein the request is received from a target reader, wherein the at least one processor is further configured to: transmit a tag context release message to a serving reader based on the authentication operation.

Aspect 12: The apparatus of any of aspects 9 through 11, wherein the at least one processor is further configured to: transmit one or more verified tag identifiers to a plurality of target readers, wherein the one or more verified tag identifiers are based on the set of tag identifiers in the request.

Aspect 13: The apparatus of any of aspects 9 through 12, wherein the tag context response message includes a subset of the set of tag identifiers associated with the at least one tag context.

Aspect 14: The apparatus of any of aspects 9 through 13, wherein the tag device is in one of a plurality of available states, wherein the plurality of available states includes at least an unregistered state, a registered state, and a terminated state.

Aspect 15: An apparatus for wireless communication, comprising: a memory; and at least one processor coupled to the memory and configured to: transmit a query command; receive a first message including at least a mobile network assigned tag identifier or an unregistered tag indicator in response to the query command; and transmit a second message including at least a temporary identifier for communication with a network node, a reader identifier, or a list of authorized readers.

Aspect 16: The apparatus of aspect 15, wherein the at least one processor is further configured to: receive a third message indicating that the mobile network assigned tag identifier has been associated with at least the temporary identifier, the reader identifier, or the list of authorized readers.

Aspect 17: The apparatus of aspect 15 or 16, wherein the second message includes the mobile network assigned tag identifier if the first message includes the unregistered tag indicator.

Aspect 18: The apparatus of any of aspects 15 through 17, wherein the at least one processor is further configured to: transmit a radio resource control setup request message including the mobile network assigned tag identifier to a network node in response to the first message; receive a radio resource control setup message including at least the temporary identifier from the network node; and transmit a radio resource control setup complete message for a tag device to the network node.

Aspect 19: The apparatus of any of aspects 15 through 18, wherein the tag device is in one of a plurality of available states, wherein the plurality of available states includes at least an unregistered state, a registered state, and a terminated state.

Aspect 20: The apparatus of any of aspects 15 through 19, wherein the query command is a group query command broadcast to a plurality of tag devices, and the first message is one of a set of messages from the plurality of tag devices based on the group query command.

Aspect 21: The apparatus of any of aspects 15 through 20, wherein the second message is a group association request message broadcast to a plurality of tag devices, and the third message is one of a set of messages from the plurality of tag devices based on the group association request message.

Aspect 22: The apparatus of any of aspects 15 through 21, wherein the at least one processor is further configured to: transmit a request for one or more tag contexts, wherein the request includes a set of mobile network assigned tag identifiers associated with the one or more tag contexts; and receive a tag context response message or a tag context failure message, wherein the tag context response message includes at least one tag context of the one or more tag contexts and a second list of authorized readers based on an authentication operation, and wherein the tag context failure message indicates that the at least one tag context of the one or more tag contexts cannot be provided to the apparatus.

Aspect 23: The apparatus of any of aspects 15 through 22, wherein the request is received from a target reader, wherein the at least one processor is further configured to: receive a tag context release message from the network node based on a result of an authentication operation associated with the mobile network assigned tag identifier.

Aspect 24: The apparatus of any of aspects 15 through 23, wherein the at least one processor is further configured to: transmit a message including at least the reader identifier to a tag device associated with a serving reader; receive a response message including at least a second mobile network assigned tag identifier and a serving reader identifier; perform an authentication operation based on at least the second mobile network assigned tag identifier; transmit an association reconfiguration message including at least a second temporary identifier for communication with a network node, the reader identifier, or a second list of authorized readers; and receive a message indicating that the second mobile network assigned tag identifier has been associated with at least the second temporary identifier, the reader identifier, or the second list of authorized readers.

Aspect 25: The apparatus of any of aspects 15 through 24, wherein the at least one processor is further configured to: transmit a request for a tag context associated with the second mobile network assigned tag identifier; and receive a tag context response message including the tag context and the second list of authorized readers.

Aspect 26: The apparatus of any of aspects 15 through 25, wherein the at least one processor is further configured to: receive a broadcast message including a list of verified mobile network assigned tag identifiers and a set of tag contexts associated with the verified mobile network assigned tag identifiers, wherein the authentication operation is based on the list of the verified mobile network assigned tag identifiers.

Aspect 27: An apparatus for wireless communication, comprising: a memory; and at least one processor coupled to the memory and configured to: receive a request to initiate a context setup for a tag device in a mobile network; perform an authentication operation for the tag device; assign a tag identifier to the tag device based on the authentication operation; and transmit a context setup message including at least the tag identifier.

Aspect 28: The apparatus of aspect 27, wherein the at least one processor configured to perform the authentication operation for the tag device is further configured to: receive at least a portion of product information associated with the tag device, wherein the portion of the product information is protected based on a public key; and verify the portion of the product information.

Aspect 29: The apparatus of aspect 27 or 28, wherein the product information includes at least a tag product identifier or an electronic product code.

Aspect 30: The apparatus of any of aspects 27 through 29, wherein the at least one processor is further configured to: generate a private key based on at least the public key, the tag identifier, or a reader identifier; receive an encrypted message from the tag device; and decrypt the encrypted message based on the private key.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. An apparatus for wireless communication, comprising:
a memory; and
at least one processor coupled to the memory and configured to:
receive a query command;
transmit a first message including at least a mobile network assigned tag identifier or an unregistered tag indicator in response to the query command; and
receive a second message including at least a temporary identifier for communication with a network node, a reader identifier, or a list of authorized readers.

2. The apparatus of claim 1, wherein the at least one processor is further configured to:
associate the mobile network assigned tag identifier with at least the temporary identifier, the reader identifier, or the list of authorized readers;
transmit a third message indicating that the mobile network assigned tag identifier has been associated with at least the temporary identifier, the reader identifier, or the list of authorized readers; and
enter a radio resource control connected mode.

3. The apparatus of claim 1, wherein the second message includes the mobile network assigned tag identifier if the first message includes the unregistered tag indicator.

4. The apparatus of claim 1, wherein the apparatus is in one of a plurality of available states, wherein the plurality of available states includes at least an unregistered state, a registered state, and a terminated state.

5. The apparatus of claim 1, wherein the at least one processor is further configured to:
generate a public key; and
transmit at least a portion of product information associated with the apparatus based on the public key for authentication of the apparatus at a mobile network entity or an application server.

6. The apparatus of claim 5, wherein the product information includes at least a tag product identifier or an electronic product code.

7. The apparatus of claim 5, wherein the at least one processor is further configured to:
generate a private key based on at least the public key, the mobile network assigned tag identifier, or a reader identifier;
encrypt a message for an entity associated with a mobile network based on the private key to obtain an encrypted message; and
transmit the encrypted message.

8. The apparatus of claim 2, wherein the at least one processor is further configured to:
receive a message from a target reader including at least a target reader identifier;
perform a validation operation based on the list of authorized readers and the target reader identifier;
transmit a fourth message including at least the mobile network tag identifier and the reader identifier based on the validation operation;
receive a fifth message including at least a second temporary identifier for communication with the network node, the target reader identifier, or a second list of authorized readers;
associate the mobile network assigned tag identifier with at least the second temporary identifier, the target reader identifier, or the second list of authorized readers; and
transmit a sixth message indicating that the mobile network assigned tag identifier has been associated with at least the second temporary identifier, the target reader identifier, or the second list of authorized readers.

9. An apparatus for wireless communication, comprising:
a memory; and
at least one processor coupled to the memory and configured to:
receive a radio resource control setup request for a tag device;
transmit a request to initiate a context setup for the tag device, wherein the request includes at least a mobile network assigned tag identifier or an unregistered tag indicator;
receive a context setup message including at least the mobile network assigned tag identifier;
transmit a radio resource control setup message including at least a temporary identifier for the tag device; and
receive a radio resource control setup complete message for the tag device.

10. The apparatus of claim 9, wherein the at least one processor is further configured to:
receive a request for one or more tag contexts;
perform an authentication operation based on a set of tag identifiers in the request; and
transmit one of a tag context response message including at least one tag context of the one or more tag contexts and a list of authorized readers or a tag context failure message based on the authentication operation.

11. The apparatus of claim 10, wherein the request is received from a target reader, wherein the at least one processor is further configured to:
transmit a tag context release message to a serving reader based on the authentication operation.

12. The apparatus of claim 10, wherein the at least one processor is further configured to:
transmit one or more verified tag identifiers to a plurality of target readers, wherein the one or more verified tag identifiers are based on the set of tag identifiers in the request.

13. The apparatus of claim 10, wherein the tag context response message includes a subset of the set of tag identifiers associated with the at least one tag context.

14. The apparatus of claim 9, wherein the tag device is in one of a plurality of available states, wherein the plurality of available states includes at least an unregistered state, a registered state, and a terminated state.

15. An apparatus for wireless communication, comprising:
a memory; and
at least one processor coupled to the memory and configured to:
transmit a query command;
receive a first message including at least a mobile network assigned tag identifier or an unregistered tag indicator in response to the query command; and
transmit a second message including at least a temporary identifier for communication with a network node, a reader identifier, or a list of authorized readers.

16. The apparatus of claim 15, wherein the at least one processor is further configured to:
receive a third message indicating that the mobile network assigned tag identifier has been associated with at least the temporary identifier, the reader identifier, or the list of authorized readers.

17. The apparatus of claim 15, wherein the second message includes the mobile network assigned tag identifier if the first message includes the unregistered tag indicator.

18. The apparatus of claim 15, wherein the at least one processor is further configured to:
transmit a radio resource control setup request message including the mobile network assigned tag identifier to a network node in response to the first message;
receive a radio resource control setup message including at least the temporary identifier from the network node; and
transmit a radio resource control setup complete message for a tag device to the network node.

19-21. (canceled)

22. The apparatus of claim 15, wherein the at least one processor is further configured to:
transmit a request for one or more tag contexts, wherein the request includes a set of mobile network assigned tag identifiers associated with the one or more tag contexts; and
receive a tag context response message or a tag context failure message, wherein the tag context response message includes at least one tag context of the one or more tag contexts and a second list of authorized readers based on an authentication operation, and wherein the tag context failure message indicates that the at least one tag context of the one or more tag contexts cannot be provided to the apparatus.

23. (canceled)

24. The apparatus of claim 15, wherein the at least one processor is further configured to:
transmit a message including at least the reader identifier to a tag device associated with a serving reader;
receive a response message including at least a second mobile network assigned tag identifier and a serving reader identifier;
perform an authentication operation based on at least the second mobile network assigned tag identifier;
transmit an association reconfiguration message including at least a second temporary identifier for communication with a network node, the reader identifier, or a second list of authorized readers; and
receive a message indicating that the second mobile network assigned tag identifier has been associated with at least the second temporary identifier, the reader identifier, or the second list of authorized readers.

25-30. (canceled)
